(19) United States
(12) Patent Application Publication
(10) Pub. No.: US 2026/0356740 A1
(43) Pub. Date: Nov. 12, 2026

(54) LIGHT-ABSORBING COMPOSITION, METHOD FOR PRODUCING LIGHT-ABSORBING COMPOSITION, COMPOSITION FOR LIGHT-ABSORBING FILM, AND LIGHT-ABSORBING FILM

(71) Applicant: Nippon Sheet Glass Company, Limited, Tokyo (JP)

(72) Inventors: Yuichiro KUBO, Tokyo (JP); Katsuhide SHIMMO, Kanagawa (JP); Tomitaka TAKAGI, Tokyo (JP); Hitomi MASUDA, Tokyo (JP)

(21) Appl. No.: 19/488,665

(22) PCT Filed: May 14, 2024
(86) PCT No.: PCT/JP2024/017865

§ 371 Date: Nov. 28, 2025

(30) Foreign Application Priority Data
May 31, 2023 (JP) 2023-089440

(51) Int. Cl. C03C 17/00; C03C 17/28

(52) U.S. Cl. CPC C03C 17/006; C03C 17/28; C03C 2217/74

(57) ABSTRACT

A light-absorbing composition includes a light-absorbing compound and a solvent. The light-absorbing compound contains phosphorus and copper. A ratio r₁ of dry mass of the light-absorbing composition to mass of the light-absorbing composition is 15% to 55%.

### TECHNICAL FIELD

The present invention relates to a light-absorbing composition, a light-absorbing composition production method, a composition for a light-absorbing film, and a light-absorbing film.

### BACKGROUND ART

In imaging apparatuses and ambient light sensors including a solid-state image sensing device, such as a charge coupled device (CCD) or a complementary metal oxide semiconductor (CMOS), any of various optical filters is disposed ahead of the solid-state image sensing device in order to obtain images with good color reproduction. Solid-state image sensing devices generally have sensitivity over a wide wavelength range extending from the ultraviolet to infrared regions. On the other hand, the visual sensitivity of humans lies only in the visible light region. Hence, a technique is known in which an optical filter for blocking a portion of infrared and ultraviolet light is disposed ahead of a solid-state image sensing device in an imaging apparatus in order to allow the sensitivity of the solid-state image sensing device to approximate to the visual sensitivity of humans. In particular, light-absorbing-type optical filters including a film or layer including a light absorbent have been attracting attention.

The transmittance properties of an optical filter including a film including a light-absorbing compound are unlikely to be dependent on the incident angle, and that makes it possible to obtain a favorable image with a smaller difference in color tone, less uneven in-plane coloring, and high color reproducibility even when light is obliquely incident on the optical filter in an imaging apparatus. Moreover, favorable images are obtained using this type of optical filter free of a light-reflecting film because such an optical filter reduces occurrence of ghosting and flare caused by multiple reflection of light. Furthermore, optical filters including a film including a light-absorbing compound are advantageous also in terms of size reduction and thickness reduction of imaging apparatuses.

Optical filters including, as a light-absorbing compound, a copper complex including a phosphonic acid are known. For example, Patent Literature 1 describes an optical filter including a light-absorbing layer having a thickness of 80 μm or less, the light-absorbing layer having a maximum transmittance of 5% or less in the range from 750 nm to 1080 nm. This light-absorbing layer includes a copper phosphonate and an organic dye, and the maximum absorption wavelength of the organic dye is in the range of 720 nm to 780 nm. Patent Literature 1 describes a light-absorbing composition that includes a copper phosphonate and an organic solvent and in which the concentration of an acid being a byproduct of generation of the copper phosphonate is 1.0 mass % or less. By using such a light-absorbing composition, the copper phosphonate and the organic dye can coexist in a single light-absorbing layer.

### CITATION LIST

### Patent Literature

Patent Literature 1: WO 2020/071461 A1

### SUMMARY OF INVENTION

### Technical Problem

As described above, in Patent Literature 1, the concentration of the acid being a byproduct in the light-absorbing composition is reduced in order to allow the copper phosphonate and the organic dye to coexist in a single light-absorbing layer. However, in the light-absorbing composition described in Patent Literature 1, the amount of the solvent is large, while the concentration of the copper complex component, namely the light-absorbing compound, is low. The concentration thereof is understood to be 7 mass % or less. Hence, a large amount of the light-absorbing composition is necessary to achieve a required light absorption capability. Furthermore, evaporation of a large amount of the solvent is required to produce a light-absorbing film by solidification of the light-absorbing composition, and that can cause issues, such as imbalance or non-uniformity of the light absorption capability on the film surface or inside the film. Thus, the light-absorbing composition described in Patent Literature 1 has room for reconsideration in order to address the issues arising from the amount of the solvent.

Therefore, the present invention provides a light-absorbing compound containing phosphorus and copper, the light-absorbing composition being advantageous in terms of addressing the issues arising from the amount of a solvent.

### Solution to Problem

The present invention provides a light-absorbing composition including:
a light-absorbing compound containing phosphorus and copper; and
a solvent, wherein
a ratio of dry mass of the light-absorbing composition to mass of the light-absorbing composition is 15% to 55%.

The present invention also provides a method for producing a light-absorbing composition, the method including:
mixing a phosphorus-containing compound and a copper salt in a first solvent;
separating the first solvent to obtain solids containing phosphorus and copper; and
adjusting a ratio of dry mass of the light-absorbing composition to mass of the light-absorbing composition to 15% to 55% by adding the solids to a second solvent and performing distillation.

The present invention also provides a composition for a light-absorbing film, the composition including:
a light-absorbing compound containing phosphorus and copper;
a solvent; and
a resin, wherein
a ratio of dry mass of the composition to mass of the composition is 10% to 55%.

The present invention also provides a light-absorbing film including:
a light-absorbing compound containing phosphorus and copper; and
a resin, wherein
the light-absorbing film has a thickness of 300 μm or less, and the light-absorbing film transmits light with wavelengths of 300 nm to 1200 nm incident at an incident angle of 0° to exhibit a transmission spectrum satisfying the following requirements (I) to (IV):
   (I) an average transmittance in a wavelength range of 800 nm to 1100 nm is 10% or less;
   (II) an average transmittance in a wavelength range of 460 nm to 580 nm is 80% or more;
   (III) a first cut-off wavelength that lies in a wavelength range from 300 nm to 400 nm and at which a transmittance is 50% is between 320 nm and 400 nm, inclusive; and
   (IV) a second cut-off wavelength that lies in a wavelength range from 600 nm to 800 nm and at which a transmittance is 50% is between 650 nm and 750 nm, inclusive.

### Advantageous Effects of Invention

The above composition for a light-absorbing film includes the light-absorbing compound containing phosphorus and copper and is advantageous in terms of addressing the issues arising from the amount of the solvent.

### BRIEF DESCRIPTION OF DRAWINGS

FIG. 1A is a cross-sectional view showing an optical filter according to an example of an embodiment of the present invention.

FIG. 1B is a cross-sectional view showing an optical filter according to another example of the embodiment of the present invention.

FIG. 1C is a cross-sectional view showing an optical filter according to yet another example of the embodiment of the present invention.

FIG. 1D is a cross-sectional view showing an optical filter according to yet another example of the embodiment of the present invention.

FIG. 1E is a cross-sectional view showing an optical filter according to yet another example of the embodiment of the present invention.

FIG. 1F is a cross-sectional view showing an optical filter according to yet another example of the embodiment of the present invention.

FIG. 2 is a transmission spectrum of a light-absorbing composition according to Example 1.

FIG. 3 is a transmission spectrum of a light-absorbing composition according to Example 4.

FIG. 4 is a transmission spectrum of a light-absorbing composition according to Example 9.

FIG. 5 is a transmission spectrum of a light-absorbing composition according to Example 11.

FIG. 6 is a transmission spectrum of a light-absorbing composition according to Example 15.

FIG. 7 is a transmittance spectrum of an optical filter according to Example 22.

FIG. 8 is a transmittance spectrum of D263 T eco manufactured by SCHOTT AG and used as a support.

FIG. 9 is a transmittance spectrum of an optical filter according to Example 23.

FIG. 10 is a transmittance spectrum of an optical filter according to Example 24.

FIG. 11 is a transmittance spectrum of an optical filter according to Example 25.

FIG. 12 is a transmittance spectrum of an optical filter according to Example 26.

FIG. 13 is a transmittance spectrum of an optical filter according to Example 27.

### DESCRIPTION OF EMBODIMENTS

Embodiments of the present invention will be described hereinafter. The following description relates to examples of the present invention, and the present invention is not limited by these.

The light-absorbing composition according to the present invention includes a light-absorbing compound and a solvent. The light-absorbing compound can absorb light with a particular wavelength. The solvent allows the light-absorbing compound to be dispersed or dissolved in the light-absorbing composition. The light-absorbing compound contains phosphorus and copper. A ratio r₁ of a dry mass of the light-absorbing composition to a mass of the light-absorbing composition is 15% to 55%. The dry mass of the light-absorbing composition is the mass of a residual remaining after a liquid component, such as the solvent, is evaporated and removed from the light-absorbing composition by heating or the like. The mass of the light-absorbing composition is the mass of the light-absorbing composition provided as a product before such solvent removal.

A concentration of a particular acid in the light-absorbing composition according to the present invention may be 0.2 mass % or less, or less than 0.2 mass %. The acid included in the light-absorbing composition may be a component included in the compound that supplies a copper component or a portion of such a component.

Addition of a curable resin to the light-absorbing composition itself or a composition prepared by adding a given solvent to the light-absorbing composition enables formation of a light-absorbing film. For example, a light-absorbing film can be provided on a surface of an optical film, an optical filter, an optical functional element, such as a lens or a diffraction grating, or the like (hereinafter collectively referred to as “support”) by solidifying a composition derived from the light-absorbing composition on that surface. A function of blocking light with a particular wavelength by absorption can be imparted thereby.

The ratio r₁ of the light-absorbing composition closely relates to an amount of the light-absorbing compound sufficient to achieve an actually required function. Because the ratio r is 15% or more, the need for a relatively large amount of the light-absorbing composition to achieve required absorption properties can be avoided. Additionally, an evaporation amount of the solvent required to be evaporated to form a light-absorbing film can be decreased, whereby evaporation of the solvent is less likely to result in an increase in haze and in-plane unevenness of absorption properties of the light-absorbing film. Because the ratio r₁ is 55% or less, aggregation of the light-absorbing compound is likely to be prevented in the light-absorbing composition or a composition prepared using the light-absorbing composition. The ratio r₁ is preferably 20% to 50%.

The light-absorbing compound is not limited to a particular substance as long as properties such as a desired transmission spectrum can be imparted to a light absorber, such as a light-absorbing film, produced using the light-absorbing composition. The light-absorbing compound may include, for example, a copper component and at least one selected from the group consisting of a phosphonic acid and a phosphoric acid ester. The light-absorbing compound may include a phosphonic acid, a phosphoric acid ester, and a copper component.

The light-absorbing compound may include phosphoric acid and a copper component, phosphinic acid and a copper component, metaphosphoric acid and a copper component, or pyrophosphoric acid and a copper component.

The light-absorbing compound may be formed as a complex of an atomic group containing phosphorus and oxygen and a copper component. Examples of the atomic group containing phosphorus and oxygen include a phosphonic acid, a phosphoric acid ester, phosphinic acid, phosphoric acid, metaphosphoric acid, and pyrophosphoric acid. The light-absorbing compound may be, for example, a phosphoric acid-copper complex represented by a composition M_{1/n}CuₘPO_{4-z}. In this composition, M is a metal other than Cu, n and m are each a natural number, and z is a positive integer smaller than 4.

As the light-absorbing compound, one of these compounds may be used alone, or a mixture of two or more of these compounds may be used. Atomic groups each containing phosphorus and oxygen, such as a phosphonic acid, a phosphinic acid, a phosphoric acid ester, or a phosphoric acid, may coexist. For example, the light-absorbing compound may be present as a compound including a phosphonic acid, a phosphoric acid ester, and a copper component. When the light-absorbing compound is a complex including a phosphonic acid and a copper component, the light-absorbing composition may include a phosphoric acid ester as a dispersant. In this case as well, compounds each including a phosphonic acid, a phosphoric acid ester, and a copper component may coexist.

In addition to the above light-absorbing compound, the light-absorbing composition may include a compound including a sulfonic acid and a copper component, a compound including an oxide of tungsten, a metal oxide, such as indium tin oxide (ITO) or antimony tin oxide (ATO), or an organic-dye-based compound. Examples of the organic-dye-based compound include a diimmonium-based compound, a cyanine-based compound, a squarylium-based compound, a phthalocyanine-based compound, and a pyrrolopyrrole-based compound.

The concept of the copper component in the light-absorbing compound includes a compound including a copper ion, a copper complex, a copper atom, and the like. The copper component can have desired absorption properties in terms of a portion of light belonging to the near-infrared region. Specifically, by electron transition in the d orbital of a divalent copper ion, light corresponding to this electron transition energy and having a wavelength belonging to the near-infrared region is selectively absorbed and thus desired near-infrared absorption properties are exhibited. The copper component may have, for example, a six-coordinate structure including one or more kinds of ligand. In this case, a higher capability to absorb light in the infrared region is expected.

The phosphonic acid that can be included in the light-absorbing compound is not limited to a particular phosphonic acid as long as a light absorber produced using the light-absorbing composition has a desired transmission spectrum. The phosphonic acid is represented, for example, by the following formula (a1) or (a2).

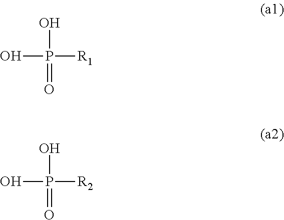

In the formula (a1), R₁ is an alkyl group or a halogenated alkyl group in which at least one hydrogen atom in an alkyl group is substituted by a halogen atom. In this case, a transmission band of a light absorber produced using the light-absorbing composition is likely to extend to a wavelength around 700 nm, and the light absorber is likely to have desired transmittance properties. Phosphonic acids having the above groups are collectively called alkylphosphonic acids. Examples of the alkylphosphonic acid include methylphosphonic acid, ethylphosphonic acid, normal (n-)propylphosphonic acid, isopropylphosphonic acid, normal (n-)butylphosphonic acid, isobutylphosphonic acid, sec-butylphosphonic acid, tert-butylphosphonic acid, and bromomethylphosphonic acid.

In the formula (a2), R₂ is, for example, an aryl group, an aryl halide group in which at least one hydrogen atom in an aryl group is substituted with a halogen atom, a group in which at least one hydrogen atom in an aryl group is substituted with a nitro group or a hydroxy group. The aryl group is, for example, a phenyl group. The aryl halide group is, for example, a halogenated phenyl group. In this case, a light absorber produced using the light-absorbing composition is more likely to have desired transmittance properties. Phosphonic acids having the above groups are collectively called arylphosphonic acids. Examples of the arylphosphonic acid include phenylphosphonic acid, bromophenylphosphonic acid, benzylphosphonic acid, fluorophenylphosphonic acid, iodophenylphosphonic acid, nitrophenylphosphonic acid, hydroxyphenylphosphonic acid, tolylphosphonic acid, xylylphosphonic acid, and naphthylphosphonic acid.

The phosphonic acid may include one phosphonic acid or a plurality of phosphonic acids selected from the above phosphonic acids as long as a light absorber produced using the light-absorbing composition has a desired transmission spectrum. Moreover, the phosphonic acid may include an alkylphosphonic acid and an arylphosphonic acid, or may include: one alkylphosphonic acid or two or more alkylphosphonic acids; and one arylphosphonic acid or two or more arylphosphonic acids. The alkylphosphonic acid(s) and the arylphosphonic acid(s) may each be bonded to the copper component to form the light-absorbing compound.

The light-absorbing composition may include, for example, a phosphoric acid ester as part of the light-absorbing compound, and/or may include a phosphoric acid ester to suppress aggregation of the light-absorbing compound in the solvent. The phosphoric acid ester facilitates appropriate dispersion of the light-absorbing compound in the light-absorbing composition and a light absorber produced using the light-absorbing composition. The phosphoric acid ester may function as a dispersant for the light-absorbing compound, and a portion of the phosphoric acid ester may react with a metal component, such as the copper component, to form a compound. For example, the phosphoric acid ester may coordinate to the light-absorbing compound or may react with the light-absorbing compound, or a portion of the phosphoric acid ester may form a complex with the copper component. The compound including the phosphoric acid ester and the copper component may absorb light with certain wavelength(s) as long as a light absorber produced using the light-absorbing composition has a desired transmission spectrum.

The phosphoric acid ester is not limited to a particular phosphoric acid ester. The phosphoric acid ester has, for example, a polyoxyalkyl group. The phosphoric acid ester may be, for example, a phosphoric acid diester represented by (b1) below or a phosphoric acid monoester represented by (b2) below. Alternatively, the phosphoric acid ester may include the phosphoric acid diester and the phosphoric acid monoester in any mixing ratio. In (b1) and (b2) below, R₂₁, R₂₂, and R₅ are each a monovalent functional group represented by —(CH₂CH₂O)ₙR₄, where n is an integer of 1 to 25, R₄ is an alkyl group having 6 to 25 carbon atoms, and R₂₁, R₂₂, and R₅ are the same or different functional groups.

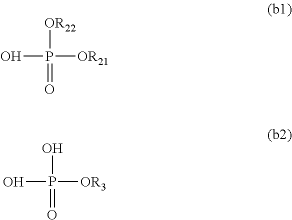

Examples of the phosphoric acid ester include PLYSURF A208N (polyoxyethylene alkyl (C12, C13) ether phosphoric acid ester), PLYSURF A208F (polyoxyethylene alkyl (C8) ether phosphoric acid ester), PLYSURF A208B (polyoxyethylene lauryl ether phosphoric acid ester), PLYSURF A219B (polyoxyethylene lauryl ether phosphoric acid ester), PLYSURF AL (polyoxyethylene styrenated phenylether phosphoric acid ester), PLYSURF A212C (polyoxyethylene tridecyl ether phosphoric acid ester), and PLYSURF A215C (polyoxyethylene tridecyl ether phosphoric acid ester). All of these are products manufactured by DKS Co., Ltd. Other examples of the phosphoric acid ester include NIKKOL DDP-2 (polyoxyethylene alkyl ether phosphoric acid ester), NIKKOL DDP-4 (polyoxyethylene alkyl ether phosphoric acid ester), and NIKKOL DDP-6 (polyoxyethylene alkyl ether phosphoric acid ester). All of these are products manufactured by Nikko Chemicals Co., Ltd. One of these phosphoric acid ester compounds may be used alone, or two or more of these phosphoric acid ester compounds may be used in combination. PLYSURF and NIKKOL are registered trademarks of DKS Co., Ltd. and Nikko Chemicals Co., Ltd., respectively.

The light-absorbing composition may include an ultraviolet absorbent capable of absorbing a portion of light belonging to the ultraviolet region. When the ultraviolet-absorbing compound is included in the light-absorbing composition and a light absorber produced using the light-absorbing composition, degradation of a resin and the light-absorbing compound that can be included in the light absorber or possibility of an undesired effect on an electronic device or the like including the light absorber can be reduced. The ultraviolet-absorbing compound is not limited to a particular compound as long as a light absorber produced using the light-absorbing composition has a desired transmission spectrum. The ultraviolet-absorbing compound is selected preferably in view of, for example, absorbing light in a desired wavelength range, having compatibility with a particular solvent, dispersing well in the light-absorbing composition or the like, and having excellent environmental durability. Examples of the ultraviolet-absorbing compound include a benzophenone-based compound, a benzotriazole-based compound, a salicylic-acid-based compound, and a triazine-based compound. Examples of the ultraviolet absorbent include Tinuvin PS, Tinuvin 99-2, Tinuvin 234, Tinuvin 326, Tinuvin 329, Tinuvin 900, Tinuvin 928, Tinuvin 405, and Tinuvin 460. These are ultraviolet-absorbing compounds manufactured by BASF, and Tinuvin is a registered trademark.

The solvent included in the light-absorbing composition is not limited to a particular solvent. The solvent may cause a reaction between the phosphorus-and-oxygen-containing compound and the copper component. When, for example, a reaction product formed by the reaction between the phosphorus-and-oxygen-containing compound and the copper component will be taken out as a solid content by solid-liquid separation a solvent capable of functioning as a poor solvent may be used. The solid-liquid separation may be, for example, filtration. This reaction product can include the above light-absorbing compound. If the process of preparation of the light-absorbing composition includes a step of separating and taking out a solid content of the light-absorbing compound from a first solvent, a portion of the first solvent may remain in the solid content and the light-absorbing composition may eventually include the first solvent. The first solvent is not limited to a particular solvent as long as the first solvent has the above role and function.

Examples of the first solvent include: alcohols, such as methanol, ethanol, n-propanol, i-propanol, n-butanol, i-butanol, 2-butanol, t-butanol, n-pentanol, i-pentanol, 2-methylbutanol, 2-pentanol, t-pentanol, 3-methoxybutanol, n-hexanol, 2-methylpentanol, 1-hexanol, 2-hexanol, 2-ethylbutanol, 1-heptanol, 2-heptanol, 3-heptanol, n-octanol, 2-ethylhexanol, 2-octanol, n-nonylalcohol, 2,6-dimethyl-4-heptanol, n-decanol, cyclohexanol, methylcyclohexanol, 3,3,5-trimethylcyclohexanol, benzyl alcohol, and diacetone alcohol; xylenes; dichlorobenzene; heptanone; cyclopentanone; cyclohexanone; cyclohexane; dimethylformamide; dimethylacetamide; toluene; heterocyclic compounds, such as tetrahydrofuran (THF) and oxetane; and chlorine-based solvents, such as methylene chloride (dichloromethane), chloroform, dichloroethane, and tetrachloroethane. One of these solvents or two or more of these solvents may be selected and mixed for use as the first solvent.

The light-absorbing composition may include a second solvent in addition to the first solvent. Sometimes the light-absorbing compound or the ultraviolet-absorbing compound that can absorb light with a particular wavelength dissolves in the light-absorbing composition, and other times it is included in fine particle form in the light-absorbing composition. When the light-absorbing composition includes the second solvent, a desired amount of such a compound can be included in the light-absorbing composition.

Examples of the second solvent include, but not limited to: alcohols, such as methanol, ethanol, n-propanol, i-propanol, n-butanol, i-butanol, 2-butanol, t-butanol, n-pentanol, i-pentanol, 2-methylbutanol, 2-pentanol, t-pentanol, 3-methoxybutanol, n-hexanol, 2-methylpentanol, 1-hexanol, 2-hexanol, 2-ethylbutanol, 1-heptanol, 2-heptanol, 3-heptanol, n-octanol, 2-ethylhexanol, 2-octanol, n-nonylalcohol, 2,6-dimethyl-4-heptanol, n-decanol, cyclohexanol, methylcyclohexanol, 3,3,5-trimethylcyclohexanol, benzyl alcohol, and diacetone alcohol; xylenes; dichlorobenzene; heptanone; cyclopentanone; cyclohexanone; cyclohexane; dimethylformamide; dimethylacetamide; toluene; heterocyclic compounds, such as tetrahydrofuran (THF) and oxetane; and chlorine-based solvents, such as methylene chloride (dichloromethane), chloroform, dichloroethane, and tetrachloroethane. One of these solvents or two or more of these solvents may be selected and mixed for use as the second solvent.

The second solvent may be determined in consideration of properties of a resin component included in a light absorber produced using the light-absorbing composition, the stability of a composition for a light-absorbing film, the stability of light absorber production steps, properties required of the light absorber, and the like. In the case where the light absorber is produced by solution casting, a solvent having a low boiling point (e.g., a chlorine-based solvent) is preferably used.

The light-absorbing composition may have a given transmission spectrum. The light-absorbing composition has, for example, a transmission spectrum satisfying (i) to (iv) below. Measurement of the transmission spectrum of the light-absorbing composition is performed, for example, for the light-absorbing composition placed in a transparent quartz cell having a physical optical path length of 1±0.25 mm for light that passes through the light-absorbing composition. The term “physical optical path length” refers to an optical path length (geometric length) determined without consideration of a refractive index of a medium. The transmission spectrum of the light-absorbing composition is measured at an environment temperature of 25±5 °C for a measurement sample prepared by adjusting the amount of the solvent added or adding an additional amount of the solvent so that the transmittance at a wavelength of 800 nm will be 10±1%.
(i) An average transmittance in a wavelength range of 800 nm to 1100 nm is 20% or less.
(ii) An average transmittance in a wavelength range of 460 nm to 580 nm is 80% or more.
(iii) A cut-off wavelength that is in a wavelength range of 300 nm to 400 nm and at which a transmittance is 50% is between 320 nm and 380 nm, inclusive.
(iv) A cut-off wavelength that lies in a wavelength range of 600 nm to 800 nm and at which a transmittance is 50% is between 680 nm and 780 nm, inclusive.

Since the transmission spectrum of the light-absorbing composition satisfies requirement (i) above, a light absorber produced using the light-absorbing composition can exhibit desired infrared-blocking properties. This can increase the correspondence between light reaching an image sensing device and the visual sensitivity of humans normally insensitive to light in the infrared region. The average transmittance in the wavelength range of 800 nm to 1100 nm is preferably 15% or less, more preferably 10% or less, even more preferably 8% or less, particularly preferably 6% or less.

By satisfying requirement (ii) above, a luminous flux of visible light having passed through a light absorber is increased, and brighter images are likely to be obtained. The average transmittance in a wavelength range of 460 nm to 580 nm is preferably 85% or more, more preferably 90% or more.

By satisfying requirement (iii) above, blocking performance against light belonging to the ultraviolet region can be enhanced. By enhancing the blocking performance against light belonging to the ultraviolet region, the correspondence between light reaching an image sensing device and the visual sensitivity of humans normally insensitive to light in the ultraviolet region can be increased. Moreover, the effect of color fringing, such as purple fringing, due to short-wavelength light included in light reaching an image sensing device can be reduced. The cut-off wavelength that lies in the wavelength range of 300 nm to 400 nm and at which the transmittance is 50% is preferably between 340 nm to 365 nm inclusive, more preferably between 345 nm to 360 nm inclusive.

By satisfying requirement (iv) above, blocking performance against light belonging to the infrared region can be enhanced. By enhancing the blocking performance against light belonging to the infrared region, the correspondence between light reaching an image sensing device and the visual sensitivity of humans normally insensitive to light in the infrared region can be increased. The cut-off wavelength that lies in the wavelength range of 600 nm to 800 nm and at which the transmittance is 50% is preferably between 700 nm to 760 nm inclusive, more preferably between 720 nm to 740 nm inclusive.

The above transmission spectrum of the light-absorbing composition may further satisfy (v) below.
(v) In a wavelength range from 300 nm to 1200 nm, a wavelength width of a band in which a transmittance is 50% or more is 350 nm to 420 nm.

Above requirement (v) is for specifying the width of a so-called transmission band, and by satisfying (v), narrowing of the visible light band and blocking of a portion of visible light can be prevented. Moreover, light outside the visible region can be sufficiently blocked. In the wavelength range of 300 nm to 1200 nm, the wavelength width corresponding to the band in which the transmittance is 50% or more is preferably 350 nm to 410 nm, more preferably 360 nm to 390 nm.

The transmission spectrum of the light-absorbing composition may further satisfy (vi) below.
(vi) An average transmittance in a wavelength range of 1100 nm to 1200 nm is 10% or less.

The light-absorbing composition including the light-absorbing compound including phosphorus, oxygen, and copper tends to have a high transmittance in a wavelength range of 1100 nm or more. For example, the transmittance at 1100 nm or more cannot be low even when the transmittance in the wavelength range of 800 nm to 1100 nm is sufficiently low. The average transmittance in the wavelength range of 1100 nm to 1200 nm is preferably 8% or less.

The transmission spectrum of the light-absorbing composition may further satisfy (vii) below.
(vii) A standard deviation of transmittances in a wavelength range of 900 nm to 1100 nm is 0.5% or less.

When there is an intention to increase the light-absorption properties in the wavelength range of 800 nm to 1200 nm by adjusting the concentration or amount of the light-absorbing compound in the light-absorbing composition, small variations in transmittance in the wavelength range of 900 nm to 1100 nm and flatness of a transmission spectrum visually observed in this wavelength range are advantageous.

By satisfying requirement (vii) above, for example, while the transmittance in the wavelength range of 800 nm to 1100 nm is adjusted to be sufficiently low, a situation where the transmittance is not sufficiently low in part of that wavelength range is likely to be avoided. The standard deviation in (vii) above is preferably 0.3% or less.

A method for producing the above light-absorbing composition includes, for example, (a), (b), and (c) below.
(a) Mixing a phosphorus-containing compound and a copper salt in the first solvent.
(b) Separating and removing the first solvent to obtain solids containing phosphorus and copper.
(c) Adjusting the ratio of the dry mass of the light-absorbing composition to the mass of the light-absorbing composition to 15% to 55% by adding the above solids to the second solvent and performing distillation.

In the above step (c), the distillation may be performed at 100 °C or lower. In this case, the solids are less likely to be thermally damaged, and a light absorber obtained using the light-absorbing composition is likely to have a desired transmission spectrum. The distillation can be performed preferably at 95 °C or lower, more preferably at 90 °C or lower, even more preferably at 85 °C or lower, particularly preferably at 75 °C or lower, especially preferably at 65 °C or lower.

In the above step (c), the distillation may be performed at a pressure lower than atmospheric pressure. In this case, even when the second solvent has a high boiling point, the second solvent can be removed by distillation at a temperature lower than the boiling point thereof. For example, the distillation may be performed at a pressure of 500 hectopascals (hPa) or lower.

In the above step (a), the copper salt is not limited to a particular copper salt. The copper salt may be a copper salt anhydride or copper salt hydrate of an organic acid, such as copper acetate, copper benzoate, copper pyrophosphate, or copper stearate, or a mixture thereof. One of these copper salts may be used alone, or two or more of these copper salts or a mixture thereof may be used.

An example of the light-absorbing composition production method will be described. The light-absorbing composition production method is not limited to the following method.

The copper salt serving as a supply source of the copper component is added to the first solvent, followed by stirring for several minutes to several hours to produce a copper salt solution. The phosphoric acid ester is added to this copper salt solution, followed by stirring for several minutes to several hours to produce a phosphoric acid ester-copper salt solution. Next, the phosphonic acid is added to another portion of the first solvent, followed by stirring for several minutes to several hours to produce a phosphonic acid solution. Then, the phosphoric acid ester-copper salt solution and the phosphonic acid solution are mixed, and are stirred for several minutes to several hours at room temperature. In this process, a so-called poor solvent, in which a reaction product including the light-absorbing compound as well can precipitate in a remarkable amount, can be selected as the first solvent. The term “poor solvent” originally refers to a solvent having low solvent power for a particular solute. However, herein, a poor solvent may have the role or function of allowing generated fine particles or the like to precipitate in a remarkable amount or aggregating fine particles or the like. The first solvent may be a poor solvent for the reaction product including the light-absorbing compound. In this case, the solid content of the reaction product is easily separated from the solvent. The material of a container used to produce the above solution or the reaction product may be glass including borosilicate glass, such as Pyrex (registered trademark), or may be stainless steel, particularly, high-quality stainless steel, such as SUS 316.

In this manner, the reaction product containing phosphorus and copper precipitates and settles in the first solvent. It is very difficult to reveal details of the process of the reaction between the phosphorus-and-oxygen-containing compound, such as the phosphonic acid or the phosphoric acid ester, and the copper component and exactly identify the reaction product. Therefore, the reaction product containing phosphorus and copper may be, for example, a compound including the phosphonic acid and the copper component (e.g., a copper phosphonate compound), a compound including the phosphoric acid ester and the copper component (e.g., a copper phosphate ester compound), a compound including the phosphonic acid, the phosphoric acid ester, and the copper component (e.g., a phosphonic acid-phosphoric acid ester copper compound), or a mixture thereof. The reaction product may include a compound other than these. For example, water (H₂O), an acetic acid ion (CH₃COO⁻), etc. can coordinate to a copper ion, and the reaction product may include these compounds and ions.

Next, the solid reaction product in the solvent is separated from the solvent by solid-liquid separation. Examples of the solid-liquid separation include filtration and centrifugation. Examples of filtration include coarse filtration (10 μm or larger: the mesh size, same as below), microfiltration (50 nm to 10 μm), and ultrafiltration (1 to 50 nm), and any of these may be employed. The filtration may be gravity filtration for which a self-weight is used as a driving force, or may be suction filtration in which depressurization is performed to save time. Examples of a filter medium include filter paper and filter cloth, and any of these may be used. If a cake layer is formed during the filtration process and serves as a filter medium, no particular filter medium is necessary. A retention particle size of the filter paper is, for example, 1 μm to 100 μm.

Next, the solid reaction product separated by the filtration is added again to another portion of the first solvent, followed by stirring for several minutes to several hours. The reaction product precipitates and settles in the first solvent, in the same manner as above. The precipitated solid reaction product in the solvent is separated from the solvent by filtration. As described above, the process including reprecipitation of the reaction product in the first solvent and separation of the solid reaction product by filtration may be performed once, or may be repeated two or more times. The reaction product is washed by this process, and that can enable, for example, removal of an unnecessary compound and impurities, facilitating purification of a desired compound. The above precipitation of the reaction product and separation of the reaction product by filtration are performed a given number of times to obtain a final reaction product as the light-absorbing compound.

The thus-obtained light-absorbing compound is added to an appropriate amount of the second solvent, followed by stirring for several minutes to several hours. Uniform dispersion of the light-absorbing compound is confirmed. It is inferred that the phosphorus-containing compound as a raw material plays the role of suppressing aggregation of the light-absorbing compound and increasing the dispersibility. In this case, while the first solvent is a poor solvent, a good solvent may be selected as the second solvent.

In order to adjust the amount of the light-absorbing compound in the second solvent, a given amount of the second solvent is removed by distillation. Ideally, it is desirable that the distillation be performed at a temperature of or around the boiling point of a solvent intended to be removed or at a temperature equal to or higher than the boiling point thereof. However, for example, distillation at a temperature higher than 100 °C can thermally affect the light-absorbing compound. Hence, to adjust the amount of the light-absorbing compound in the solvent, distillation for removing the solvent is preferably performed at a temperature of 100 °C or lower. In the case where the second solvent selected has a boiling point, for example, higher than 100 °C, distillation under reduced pressure (vacuum distillation) may be performed. For example, when toluene, whose boiling point is 111 °C under atmospheric pressure, is used as the second solvent, distillation at 100 °C or lower is achievable by adjusting the internal pressure of a tank of a distiller, for example, at 500 hPa or less (approximately 0.5 atmospheric pressure or less). Caution is required against rapid distillation of the solvent because rapid distillation of the solvent sharply increases the concentration of the light-absorbing compound and is likely to cause aggregation of the light-absorbing compound. When distillation under reduced pressure is performed to adjust the dry mass of the light-absorbing composition, the pressure is preferably 350 hPa or less, and may be more preferably 250 hPa or less. What is important is conditions for suppressing a sharp temperature rise and bumping. A sudden change in the conditions needs to be avoided even when a lower maximum temperature is achieved by lowering the pressure during the vacuum distillation. Suppressing a sudden state change of the compound including the phosphorus component and the copper component during the purification is important. When regarded as the temperature of a bath (oil bath) for heating the light-absorbing composition, the heating temperature for obtaining the light-absorbing composition by vacuum distillation is preferably 85 °C or lower, more preferably 65 °C or lower, and may be even more preferably 45 °C or lower.

The light-absorbing composition whose ratio r₁ is adjusted to 15% to 55% is obtained in this manner. The ratio r₁ is determined, for example, as follows. A liquid sample of the obtained light-absorbing composition is obtained and measured for its mass M1. Next, the sample of the light-absorbing composition is heated in a heating oven, so that its solid content alone remains. Mass m1 of the remaining solid content is measured. The value of m1/M1 is calculated to determine the ratio r₁ in the light-absorbing composition.

An acid concentration in the thus-prepared light-absorbing composition is less than 0.2 mass %. The acid that can be included in the light-absorbing composition is acetic acid when the copper salt in (a) includes copper acetate, and is benzoic acid when the copper salt in (a) includes copper benzoate. The acid that can be included in the light-absorbing composition is a component included in the supply compound of the copper component. If the acid concentration in the light-absorbing composition is 0.2 mass % or more, aggregation, discoloration, and the like due to aggregation and redispersion occur, and hence the amount of the light-absorbing compound that can be included in an optical film cannot be increased. This makes it inevitable to increase the thickness of the film so as to achieve a certain absorption capability, hindering achievement of a lower-profile imaging apparatus or the like when the film is incorporated therein. The acid concentration in the light-absorbing composition is preferably 0.18 mass % or less, even more preferably 0.15 mass % or less. The acid concentration in the light-absorbing composition is measured, for example, by capillary electrophoresis.

As well as an additive that can exhibit an additional function, a resin may be added as appropriate to the light-absorbing composition during production of the light-absorbing composition. Because the light-absorbing composition is used, as described below, as a raw material of a composition for a light-absorbing film, the light-absorbing composition may include a given amount of a resin component to be included in the composition for a light-absorbing film. The additive is, for example, but not limited to, an ultraviolet-absorbing compound as described above, a plasticizer, fine particles, a leveling agent, or a release agent. Addition of the release agent is effective, for example, when the light-absorbing composition is used to produce a film-shaped light absorber by solution casting. These additives may be added in a later step for producing the composition for a light-absorbing film.

When the resin component which is a solid body, such as a granule, powder, or a pellet, is added to the light-absorbing composition, the resin component preferably dissolves in the second solvent. A solvent that can dissolve the resin component may be selected as the second solvent. The resin component may be added before the light-absorbing compound or a solution containing the light-absorbing compound is added to the second solvent.

A composition according to the present invention for a light-absorbing film includes a light-absorbing compound, a solvent, and a resin. The light-absorbing compound can absorb light with a particular wavelength. The solvent allows the light-absorbing compound to be dispersed or dissolved in the composition for a light-absorbing film. The light-absorbing compound contains phosphorus and copper. A ratio r₂ of dry mass of the composition for a light-absorbing film to mass of the composition for a light-absorbing film is 10% to 55%. The dry mass of the composition for a light-absorbing film is the mass of a residual remaining after a liquid component, such as the solvent, is evaporated and removed from the composition for a light-absorbing film by heating or the like. The mass of the composition for a light-absorbing film is the mass of the composition provided as a product before such solvent removal.

The composition for a light-absorbing film is, for example, applied to a surface of a support or the like. The composition for a light-absorbing film is a precursor of a light-absorbing film formed into a film by a known method. The light-absorbing film absorbs light with a particular wavelength, and is self-supporting. The light-absorbing film forms an article, such as a film, that has a small thickness relative to its principal surface and that are traded and distributed, or has a small thickness relative to its principal surface and is on a surface of some article. The light-absorbing film may be a layer or coating on a surface of a support, such as an electronic component, an optical component, or a substrate, or may be self-supporting without the need for a support or the like. The support has the function and role of supporting the light-absorbing film. The composition for a light-absorbing film is a liquid composition including, for example: the above light-absorbing composition or one (hereinafter referred to simply as “light-absorbing composition”) obtained by subjecting the above light-absorbing composition to a given treatment; a resin; and a solvent, and functions as a precursor for formation of a light-absorbing film. The light-absorbing film may be called a film when having a thickness of less than 250 μm, and may be called a sheet when having a thickness of 250 μm or more.

In the composition for a light-absorbing film, the resin is, for example, for enclosing the light-absorbing compound included in the light-absorbing composition. The solvent is, for example, for allowing the resin to be dissolved or be dispersed in the composition for a light-absorbing film. Description of the light-absorbing compound in the light-absorbing composition is applicable to the light-absorbing compound included in the composition for a light-absorbing film.

In application of the composition for a light-absorbing film and processing into a film (hereinafter “application, etc.”), the smaller viscosity the composition for a light-absorbing film has, the more easily the coating film spreads. However, if the viscosity is too small, it is difficult to form a coating film to have a thickness equal to or larger than a given film thickness. On the other hand, a large viscosity of the composition for a light-absorbing film makes it easier to increase the film thickness, but can decrease the ease of application. Since the ratio r₂ is 10% to 55% for the composition for a light-absorbing film, the composition for a light-absorbing film is likely to have desired handleability and ease of casting and thus improve the ease of application. The composition for a light-absorbing film may be referred to as a coating solution due to how it is handled and how a light-absorbing film is formed with it.

The composition for a light-absorbing film may include, for example, an ultraviolet-absorbing compound, a light stabilizing agent, a plasticizer, fine particles, a leveling agent, or a silane coupling agent. The composition for a light-absorbing film may be used to produce a light-absorbing film by solution casting. In this case, a substance having a function aimed at enhancing releasability from a surface for casting may be added to the composition for a light-absorbing film.

The resin included in the composition for a light-absorbing film can enclose the light-absorbing compound. This resin is not limited to a particular resin. The resin may be a thermosetting resin or a thermoplastic resin. Examples of the thermosetting resin include epoxy resins (EP) and silicone resins. Examples of the thermoplastic resin include acrylic resins (PMMA), polyamide resins (PA), polycarbonate resins (PC), polyethylene terephthalate resins (PET), cyclic polyolefin resins (cycloolefin resin) (COP), polyvinyl butyral resins (PVB), polyethersulfone resins (PES), and polyester resins. One of the resins or a mixture of two or more of the resins may be used. Examples of the epoxy resin include EPICLON (registered trademark) manufactured by DIC Corporation. Examples of the silicone resin include DOWSIL (registered trademark) manufactured by Nagase & Co., Ltd. and various silicone resins manufactured by Shin-Etsu Chemical Co., Ltd. Examples of the acrylic resin include ACRYPET (registered trademark) manufactured by Mitsubishi Chemical Corporation and OZ-1000 and OZ-1100 manufactured by Resonac Corporation. Examples of the cyclic olefin resin include ARTON (registered trademark) manufactured by JSR Corporation, ZEONOR (registered trademark) manufactured by Zeon Corporation, and APEL (registered trademark) manufactured by Mitsui Chemicals, Inc. Examples of the PVB include Mowital (registered trademark) manufactured by KURARAY CO., LTD. Examples of the polyester resin include OKP series manufactured by Osaka Gas Chemicals Co., Ltd.

An amount of the resin in the composition for a light-absorbing film is not limited to a particular amount. The amount thereof is, for example, 5 mass % to 60 mass %, and preferably 15 mass % to 50 mass %.

In the composition for a light-absorbing film, the solvent is, for example, suitable for dissolving the resin. In this case, for example, a granular, powder, or pellet-shaped resin may be used in preparation of the composition for a light-absorbing film. For example, when a light-absorbing film is formed from the composition for a light-absorbing film by solution casting, drying is performed after the casting so as to remove the solvent. Therefore, a solvent having a relatively low boiling point may be selected, and, for example, a solvent having a boiling point of 70 °C or lower may be selected. In this case as well, it is important that the solvent has properties suitable for dissolving the resin. Meanwhile, the solvent has, for example, a boiling point higher than 30 °C. This makes it easy to avoid an increase in viscosity due to evaporation of the solvent during preparation or mixing or significant decrease in pot life.

An amount of the solvent in the composition for a light-absorbing film is not limited to a particular value as long as the ratio r₂ is 10% to 55%. A ratio of the amount of the solvent to the amount of the resin in the composition for a light-absorbing film is, for example, 0.1 to 50, preferably 0.3 to 20 on a mass basis. Examples of the solvent having a low boiling point and included in the composition for a light-absorbing film include acetone (boiling point: 56 °C), chloroform (boiling point: 61 °C), dichloromethane (methylene chloride) (boiling point: 40 °C), diethyl ether (boiling point: 35 °C), ethyl formate (boiling point: 52 °C), hexane (boiling point: 69 °C), methanol (boiling point: 65 °C), methyl acetate (boiling point: 57 °C), pentane (boiling point: 36 °C), and tetrahydrofuran (boiling point: 66 °C). One of the solvents or a mixture of two or more of the solvents may be used.

The composition for a light-absorbing film may include an ultraviolet-absorbing compound capable of absorbing a portion of light belonging to the ultraviolet region. Since the composition for a light-absorbing film and also the light-absorbing film include the ultraviolet-absorbing compound, ultraviolet light which degrades the resin and the light-absorbing compound or which can exercise an undesired effect on an electronic device or the like can be blocked. The ultraviolet-absorbing compound is not limited to a particular compound as long as a light-absorbing film exhibits a desired transmission spectrum.

The ultraviolet-absorbing compound is selected preferably in view of, for example, absorbing light in a desired wavelength range, having compatibility with a particular solvent, dispersing well in the composition for a light-absorbing film, and having excellent environmental durability. Examples of the ultraviolet-absorbing compound include a benzophenone-based compound, a benzotriazole-based compound, a salicylic-acid-based compound, and a triazine-based compound, and one of the compounds or a mixture of two or more of the compounds may be included in the composition for a light-absorbing film. Examples of the ultraviolet absorbent include Tinuvin PS, Tinuvin 99-2, Tinuvin 234, Tinuvin 326, Tinuvin 329, Tinuvin 900, Tinuvin 928, Tinuvin 405, and Tinuvin 460. These are ultraviolet-absorbing compounds manufactured by BASF, and Tinuvin is a registered trademark.

The amount of the ultraviolet absorbent in the composition for a light-absorbing film is not limited to a particular value. A ratio of the amount of the ultraviolet absorbent to the amount of the resin in the composition for a light-absorbing film is, for example, 0.00001 to 0.2, preferably 0.0001 to 0.05, on a mass basis.

The composition for a light-absorbing film may include, for example, a light stabilizer. In this case, degradation of the resin or the light-absorbing compound by the effect of light including ultraviolet light during formation of a light-absorbing film can be reduced. The above ultraviolet-absorbing compound may also function as a light stabilizer. The light stabilizer is, for example, a hindered amine light stabilizer (HALS). A ratio of the amount of the light stabilizer to the amount of the resin in the composition for a light-absorbing film is, for example, 0.00001 to 0.2, preferably 0.0001 to 0.05, on a mass basis. As the hindered amine light stabilizer, for example, ADK STAB series manufactured by ADEKA CORPORATION may be used, or a mixture of a plurality of light stabilizers may be used.

The composition for a light-absorbing film may include a silane coupling agent. Silane coupling agents are included in various compositions commonly in order to strengthen a bond between an organic material and an inorganic material. For example, when a light-absorbing film is formed on an inorganic support, such as glass, after casting of the composition for a light-absorbing film, the silane coupling agent can strengthen a bond between the organic resin component included in the light-absorbing film and the support to enhance the peeling resistance. In addition, the silane coupling agent can strengthen a bond between the inorganic light-absorbing compound and the resin component included in the light-absorbing film to enhance, for example, the weather resistance.

Examples of the silane coupling agent include an alkoxysilane monomer and a hydrolysate thereof. Examples of the silane coupling agent include tetramethoxysilane, tetraethoxysilane, methyltrimethoxysilane, methyltriethoxysilane, dimethyldiethoxysilane, dimethyldimethoxysilane, phenyltrimethoxysilane, phenyltriethoxysilane, 3-glycidoxypropyltrimethoxysilane, 3-glycidoxypropyltriethoxysilane, and 3-glycidoxypropylmethyldiethoxysilane. The silane coupling agent may be an aminosilane compound. Examples of the aminosilane compound include 3-aminopropyltriethoxysilane, N-2-(aminoethyl)-3-aminopropyltrimethoxysilane, N-2-(aminoethyl)-N′-2-(aminoethyl)-3-aminopropyltriethoxysilane, and 3-anilinopropyltrimethoxysilane. The silane coupling agent may be a vinylsilane compound. Examples of the vinylsilane compound include vinyltrimethoxysilane and N-2-(N-vinylbenzylamino ethyl)-3-aminopropyltrimethoxysilane. The silane coupling agent may be another silane compound. Examples of the other silane compound include 3-methacryloxypropyltrimethoxysilane, 3-chloropropyltrimethoxysilane, and 3-mercaptopropyltrimethoxysilane. The composition for a light-absorbing film may include one of the silane coupling agents or a mixture of two or more of the silane coupling agents depending on the type of the included resin.

A ratio of the amount of the silane coupling agent to the amount of the resin in the composition for a light-absorbing film is, for example, 0.01 to 0.2, preferably 0.02 to 0.1, on a mass basis.

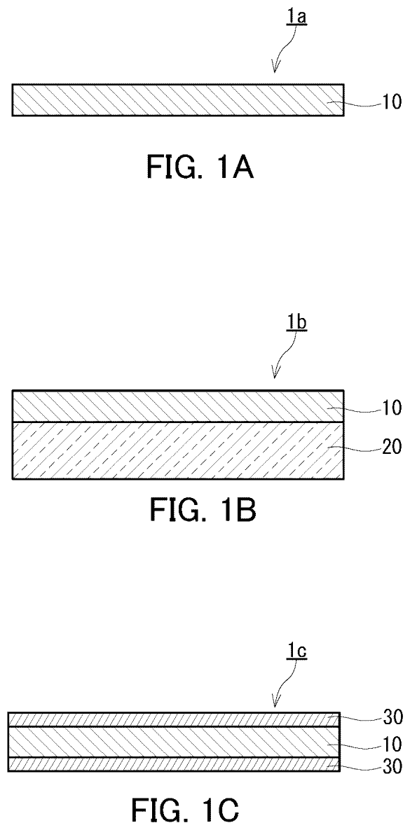

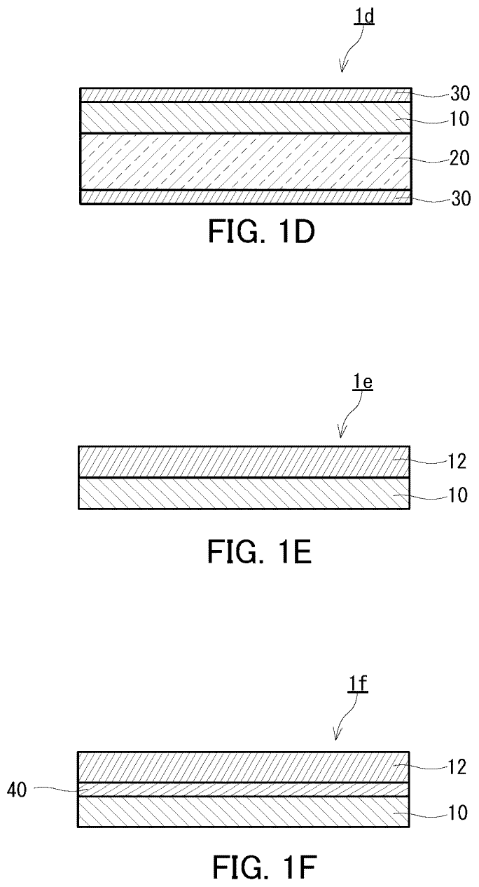

For example, a light-absorbing film 10 can be provided using the composition for a light-absorbing film. As shown in FIG. 1A, for example, the light-absorbing film 10 may be self-supporting. In this case, an optical filter 1a including only the light-absorbing film 10 can be provided.

The light-absorbing film 10 includes a light-absorbing compound containing phosphorus and copper and a resin. The description of the light-absorbing compound of the above light-absorbing composition or the above composition for a light-absorbing film is applicable to the light-absorbing compound included in the light-absorbing film 10. The description of the resin of the composition for a light-absorbing film is applicable to the resin included in the light-absorbing film 10.

The light-absorbing film 10 has a thickness of 300 μm or less. Additionally, the light-absorbing film 10 transmits light with wavelengths of 300 nm to 1200 nm incident at an incident angle of 0° to pass through to exhibit a transmission spectrum satisfying (I) to (IV) below.
(I) An average transmittance in a wavelength range of 800 nm to 1100 nm is 20% or less.
(II) An average transmittance in a wavelength range of 460 nm to 580 nm is 80% or more.
(III) A first cut-off wavelength that lies in the wavelength range of 300 nm to 400 nm and at which a transmittance is 50% is between 320 nm to 400 nm, inclusive.
(IV) A second cut-off wavelength that lies in the wavelength range of 600 nm to 800 nm and at which a transmittance is 50% is between 650 nm to 750 nm, inclusive.

When the light-absorbing film 10 is mounted in an imaging apparatus, the light-absorbing film 10 having a thickness of 300 μm or less is advantageous, for example, in terms of achieving a lower-profile imaging apparatus or a lower-profile camera module of an imaging apparatus. The thickness of the light-absorbing film 10 is preferably 70 μm to 280 μm, more preferably 80 μm to 250 μm. In this case, a significant decrease of the stiffness and the mechanical strength of the light-absorbing film 10 can be avoided, and the light-absorbing film 10 is easy to handle.

Since the transmission spectrum of the light-absorbing film satisfies requirement (I) above, the light-absorbing film 10 can exert sufficient infrared-blocking performance. This can increase the correspondence between light reaching an image sensing device and the visual sensitivity of humans normally insensitive to light in the infrared region. In the light-absorbing film 10, the average transmittance in the wavelength range of 800 nm to 1100 nm is preferably 15% or less, more preferably 10% or less. In an attempt to further decrease the transmittance in the wavelength range of 800 nm to 1100 nm, for example, a light-absorbing film may include an additional light-absorbing compound as well as the light-absorbing compound including the phosphonic acid, the phosphoric acid ester, and the copper component. Examples of the other light-absorbing compound include an organic dye, a pigment, a compound having a composition M_{1/n}CuₘPO_{4-z}, a metal oxide such as ITO or ATO, and a compound including tungsten oxide. In the composition M_{1/n}CuₘPO_{4-z}, M is a metal element other than Cu, n and m are each a natural number, and z is a positive integer smaller than 4. One of these light-absorbing compounds or two or more of these light-absorbing compounds may be included in the light-absorbing film 10. Alternatively, two or more of the light-absorbing compounds including the phosphonic acid, the phosphoric acid ester, and the copper component may be included in the same light-absorbing film 10. The above light-absorbing compound may be included in the light-absorbing composition or the composition for a light-absorbing film in advance. As another technique used in an attempt to further decrease the transmittance in the wavelength range of 800 nm to 1100 nm, a laminate including the light-absorbing film 10 including the phosphonic acid, the phosphoric acid ester, and the copper component and another light-absorbing film including the above additional light-absorbing compound may be formed.

By satisfying requirement (II) above, a luminous flux of light belonging to the visible region and passing through the light-absorbing film 10 to reach an image sensing device is increased, which is advantageous in terms of forming brighter images.

By satisfying requirement (III) above, blocking performance against light belonging to the ultraviolet region can be enhanced using the light-absorbing film 10. This can increase the correspondence between light reaching an image sensing device and the visual sensitivity of humans normally insensitive to light in the ultraviolet region. The likelihood of color fringing, such as purple fringing, due to short-wavelength light included in light reaching an image sensing device can be decreased.

By satisfying requirement (IV) above, blocking performance against light belonging to the infrared region can be enhanced using the light-absorbing film 10. This can increase the correspondence between light reaching an image sensing device and the visual sensitivity of humans normally insensitive to light in the infrared region.

In the above transmission spectrum of the light-absorbing film 10, a transmittance at a wavelength of 430 nm may be 80% or more. This is more advantageous in terms of forming brighter images.

The above transmission spectrum of the light-absorbing film 10 may satisfy at least one selected from the group consisting of (V) to (IX) below.
(V) A transmittance at a wavelength of 800 nm is 3% or less.
(VI) A transmittance at a wavelength of 900 nm is 1.5% or less.
(VII) A transmittance at a wavelength of 950 nm is 0.5% or less.
(VIII) A transmittance at a wavelength of 1000 nm is 0.5% or less.
(IX) A transmittance at a wavelength of 1100 nm is 0.5% or less.

As shown in FIG. 1B, an optical filter 1b including the light-absorbing film 10 may be provided. The optical filter 1b includes a support 20 in addition to the light-absorbing film 10. The support 20 supports the light-absorbing film 10. For example, the above composition for a light-absorbing film is applied to the support 20 to give the light-absorbing film 10. The support 20 is not limited to a particular support as long as the optical filter 1b has desired performance. Additionally, the shape of the support 20 is not limited to a particular shape.

In terms of ensuring the ease of application of the composition for a light-absorbing film and the versatility of the optical filter, the support 20 may be, as shown in FIG. 1B, in a parallel flat plate shape. The support 20 may include a curved face or may have a projecting or recessed face. The support 20 is not necessarily in a plate shape. The support 20 may have an optical function, and examples of the support having an optical function include optical elements, such as a lens, a polarizer, a prism, a reflective element, and a diffraction grating. These optical elements include a face including a curved face and a flat face, in some cases. Furthermore, the support 20 may be, for example, a photoelectric conversion element, such as a photodiode or a phototransistor. The support 20 may be an image sensor in which a lot of photoelectric conversion elements, such as CCDs or CMOSs, are arranged or an image sensor equivalent to such an image sensor. In some cases, the light absorber 10 may be formed directly on a light-receiving face of such an image sensor or window glass thereof. Yet another example of the support 20 is a display unit, such as a display of a mobile terminal or the like.

The support 20 may be transparent. When the support 20 is transparent, a transmission spectrum of the light-absorbing film is more reflective of a transmission spectrum of the optical filter 1b. When the support 20 is transparent, in a transmission spectrum of a 3 mm-thick parallel flat plate formed of the same material as that of the support 20, the transmittance in the wavelength range of 360 nm to 900 nm may be 90% or more, and the transmittance in the wavelength range of 350 nm to 1200 nm may be 85% or more.

Examples of the support 20 having such transparency include a glass support. In this case, examples of the glass include a transparent glass formed of a silicate glass such as soda-lime glass or borosilicate glass or a phosphate or fluorophosphate glass containing a coloring component such as Cu or Co. The phosphate or fluorophosphate glass containing the coloring component is, for example, an infrared-absorbing glass, and has light-absorption properties in itself. In the case of using the light-absorbing film together with an infrared-absorbing glass support, an optical filter having desired optical properties can be produced by adjusting the light-absorption properties and transmission spectra of the light-absorber and the substrate, and the flexibility in designing optical filters is high.

The support 20 may be a support formed of a resin. In this case, examples of the resin include cyclic olefin resins, acrylic resins, polyimide resins, polyetherimide resins, sulfone resins, polyethersulfone resins, polycarbonate resins, and silicone resins. Resins have extremely high processability and high formability, compared to glasses. Hence, supports, such as optical elements, in various shapes can be produced from resins.

The support 20 may be a light-absorbing support. The light-absorbing support has, by itself, the function of absorbing a portion of light with a particular wavelength and supports the light-absorbing film 10. The light-absorbing support may be a support formed of the above coloring glass including the coloring component, such as Cu or Co, or may be a support formed of a resin enclosing a dye, a pigment, or a coloring material.

As shown in FIG. 1C, an optical filter 1c including the light-absorbing film 10 and an antireflection film 30 may be provided. The antireflection film 30 is placed on a surface of the light-absorbing film 10, and prevents or reduces a Fresnel reflection at the interface between the light-absorbing film 10 and air. The antireflection film 30 may be a single-layer film or a multilayer film of a dielectric. In this case, the dielectric is not limited to a particular dielectric. Examples of the dielectric include metal compounds, such as MgF, SiO₂, TiO₂, and Ta₂O₃. One dielectric or two or more dielectrics may be selected from these dielectrics, and the antireflection film 30 may be formed as a laminate thereof. Examples of the method for producing the antireflection film 30 include deposition and sputtering. Another example of the method for producing the antireflection film 30 is sol-gel process. By sol-gel process, a film of a metal oxide (organic-inorganic compound) partially including an organic group is formed by hydrolysis and polycondensation of a metal alkoxide. For example, a Si-containing liquid alkoxide is subjected to hydrolysis on a surface of a target article or the light-absorbing film under the presence of a water component, and is successively subjected to polycondensation to be solidified. An antireflecting or reflection-reducing film having an adjusted film thickness can be produced in this manner. A Si-containing alkoxide is inexpensive, hydrolysis and polycondensation reactions thereof are easily adjusted, and the resulting film is likely to have a relatively low refractive index. Furthermore, when the film obtained by sol-gel process is required to have a better antireflecting or reflection-reducing capability, for example, the alkoxide enclosing fine hollow particles, such as hollow silica, is advantageous in that the refractive index of the film can be further decreased.

As shown in FIG. 1D, an optical filter 1d including the light-absorbing film 10, the support 20, and the antireflection film 30 may be provided.

As shown in FIG. 1E, an optical filter 1e including the light-absorbing film 10 (a first light-absorbing film) and a second light-absorbing film 12. The second light-absorbing film 12 can be disposed for enhancement of the light absorption capability, such as adjustment of a blocked wavelength band and reduction of transmittance. The second light-absorbing film 12 includes, for example, a second light-absorbing compound and a resin component. The second light-absorbing compound is a compound that can absorb light with a wavelength in a range different from a wavelength range of light absorbed by the light-absorbing compound included in the light-absorbing film 10. For example, the maximum absorption wavelength of the second light-absorbing compound is different from the maximum absorption wavelength of the light-absorbing compound included in the light-absorbing film 10. The second light-absorbing compound may be a light-absorbing compound including: a phosphorus-and-oxygen-containing compound different from the phosphorus-and-oxygen-containing compound being the light-absorbing compound included in the light-absorbing film 10; and a copper component. The second light-absorbing compound may include, for example, an aryl-including phosphonic acid, a copper component, a polyoxyalkyl ether phosphoric acid ester, or a reaction product thereof. In this case, the second cut-off wavelength is easily made shorter, and desired transmission properties can be imparted to the optical filter depending on the application of the optical filter.

The second light-absorbing compound is, for example, a phosphoric acid-copper complex represented by the above composition M_{1/n}CuₘPO_{4-z}, a compound including a sulfonic acid and a copper component, a compound including an oxide of tungsten, or a metal oxide, such as ITO or ATO.

As shown in FIG. 1F, an optical filter 1f including the light-absorbing film 10, the second light-absorbing film 12, and an intermediate layer 40 may be provided. The intermediate layer 40 is a layer physically separating the light-absorbing film 10 and the second light-absorbing film 12, and may be provided, in particular, to prevent an interaction between the light-absorbing film 10 and the second light-absorbing film 12. The intermediate layer 40 may include, for example, a dielectric formed of, for example, any of the metal compounds mentioned as the material of the above antireflection film 30, or may include an organic-group-including metal oxide (an organic-inorganic compound) formed by sol-gel process.

The light-absorbing film 10 is formed, for example, using the above composition for a light-absorbing film. The method for producing the light-absorbing film 10 is not limited to a particular method as long as a film that can block a portion of light in a particular wavelength range can be formed. In the case of producing the light-absorbing film 10 on the support 20, the method for depositing (applying) the composition for a light-absorbing film on the support 20 is, for example, dipping, casting, spraying, spin coating, inkjet coating, or slit die coating. The method for producing the light-absorbing film 10 may be determined as appropriate taking into account specifications, performance, mass productivity, yield, and the like of the light-absorbing film 10.

Spin coating is a method in which, while the support 20 is rotated using a spindle or the like, the composition for a light-absorbing film is dropped onto the support 20 so that the composition for a light-absorbing film spreads outward from the center of the spindle to be deposited on the support 20. Spin coating allows precise control of film thickness through adjustment of spin coating conditions. Additionally, this coating method is suitable for a case where a component or the like that is limited in size is used as the support 20 or where the light-absorbing film 10 is formed on a non-planar surface, such as a projecting or recessed surface.

Casting is a method in which the composition for a light-absorbing film is cast on the support 20 by dropping or extrusion of the composition in liquid form so as to form a coating film having a desired thickness, and is also called solution casting. The dropping of the composition for a light-absorbing film onto the support 20 may be performed using a dispenser or a slot die, but the applicator is not limited to these. The support 20 on which casting is carried out is a support having a flat and smooth surface. Casting can be carried out on a support having such a small size that the support is fabricated on a bench and a relatively large support.

When an optical filter consisting of the light-absorbing film 10 is produced, the method for producing the light-absorbing film 10 is, for example, casting, extrusion molding, or calendering. Among these, casting may be used in view of, for example, flatness and smoothness, low haze, and mass productivity required of optical components, and thermal properties of the light-absorbing compound included in the composition for a light-absorbing film. In casting, for example, the composition for a light-absorbing film is dropped or extruded onto a principal surface of a flat and smooth glass sheet, a metallic belt, or a metallic plate using a dispenser, a die, or the like to be cast in a thin film, and the resulting cast film is dried or reacted to obtain a solidified product. Then, the solidified product is peeled off the glass sheet, the metallic belt, or the metallic plate to give the light-absorbing film 10 that is self-standing.

Casting is applicable, as in fabrication of the light-absorbing film 10 in a laboratory setting, to cases where the light-absorbing film 10 in a small size is fabricated for study, experiment, and trial and where a relatively large size and high mass productivity are required. In a production method suitable for low-volume production, for example, a glass sheet having a flat and smooth principal surface is used as a temporary support, and the composition for a light-absorbing film is cast on the glass sheet to have a given thickness. After that, a portion of the solvent included in the composition for a light-absorbing film is evaporated, and the curable resin is reacted. The cast composition for a light-absorbing film is thus dried to give a solidified product. The solidified product is then peeled off to give the light-absorbing film 10 that is self-standing. The peeled solidified product may be subjected to a treatment, such as post-curing. For example, an agent, such as a surface treatment agent including a fluorine compound, for promoting peeling of the solidified product may be applied to the principal surface of the glass sheet as a temporary support so as to facilitate peeling of the solidified product. Alternatively, to produce the light-absorbing film 10 having a given thickness, for example, the thickness of the coating film may be adjusted by disposing a frame in any shape on a surface of the temporary support and dropping a given amount of the composition for a light-absorbing film inside the frame and casting the composition.

A method by which the light-absorbing film 10 having a large area is continuously produced is considered as a production method suitable for mass production. For example, the composition for a light-absorbing film is deposited and cast using a slit die or the like on a flat and smooth metallic belt of a crawler track, the belt being continuously moved by a plurality of rolls. A portion of the solvent included in the composition for a light-absorbing film is evaporated on the belt and the curable resin is reacted. The cast composition for a light-absorbing film is thus dried to give a solidified product. The dried solidified product is peeled off the belt, and is, for example, passed through an oven so as to almost fully evaporate the solvent or promote the reaction as post-curing. Subsequently, the film-shaped solidified product is continuously conveyed. If necessary, the solidified product may be drawn using a plurality of rolls, and the light-absorbing film 10 may be wound using a roll for winding to obtain a wound body of the light-absorbing film 10.

When the light-absorbing film 10 is produced by casting, the amount of the resin in the composition for a light-absorbing film is, for example, 10 mass % to 35 mass %. In this case, even when the light-absorbing film 10 is required to be thin, the viscosity of the composition fed from a slot die is likely to be adjusted in a desired range, and the state of casting can also exhibit good casting properties. Moreover, a decrease of the ease of casting of the composition for a light-absorbing film can be avoided, and unevenness of the thickness of the light-absorbing film 10 is likely to be small. The amount of the resin in the composition for a light-absorbing film is preferably 15 mass % to 30 mass %.

### EXAMPLES

Hereinafter, the present invention will be described in more detail with reference to examples. The present invention is not limited to the examples given below.

### Example 1

An amount of 4.88 g of copper acetate monohydrate (manufactured by KANTO CHEMICAL CO., INC.) and 195.12 g of ethanol (manufactured by KANTO CHEMICAL CO., INC., EL grade for the electronics industry) were mixed, and were stirred for three hours to give a copper acetate solution. Next, 2.572 g of a phosphoric acid ester compound (manufactured by DKS Co., Ltd.; product name: PLYSURF A208N) was added to the copper acetate solution, followed by stirring for 30 minutes to give a solution A1 being a copper acetate-phosphoric acid ester solution. Then, 2.886 g of n-butylphosphonic acid and 40 g of ethanol were added, and were stirred for 10 minutes to give a solution B1 being a phosphonic acid solution. Subsequently, the solution B1 was added to the solution A1 under stirring. This was followed by stirring at room temperature for 15 minutes to cause a reaction, giving a solution C1 being a phosphoric acid ester-phosphonic acid-copper solution. For the solution C1, settlement of solids assumed to have been generated by the reaction was able to be visually confirmed. The reaction product is considered to be a compound including a portion or all of the phosphonic acid, the phosphoric acid ester, and the copper component.

The solution C1 was subjected to suction filtration to give solids of the reaction product. The solid reaction product was added to 200 g of ethanol, and was stirred at room temperature for 10 minutes. Then, suction filtration was performed again to give a solid reaction product obtained after one purification. Furthermore, this solid reaction product obtained after one purification was added to 80 g of toluene, followed by stirring at room temperature for 10 minutes to give a solution D1. For the solution D1, no solids of the reaction product were visually confirmed, and the reaction product was dispersed therein. This indicates that the solid reaction product included a certain amount of the phosphoric acid ester having the dispersing effect and the phosphoric acid ester contributed to the dispersion of the reaction product in the toluene.

The solution D1 was placed in a flask and subjected to solvent removal using a rotary evaporator (manufactured by Tokyo Rikakikai Co., Ltd.; product code: N-1110SF) under heating by means of an oil bath (manufactured by Tokyo Rikakikai Co., Ltd.; product code: OSB-2100) set at 85 °C. During this operation, the flask was carefully depressurized stepwise from the atmospheric pressure to a given pressure using a vacuum pump to prevent bumping. The operation was finished after confirming that the solvent had decreased to a certain amount. A solution E1 was obtained in this manner. Ultimately, 39.71 g of a light-absorbing composition E1 was obtained. It was confirmed that a reaction product including a portion or all of the phosphonic acid, the phosphoric acid ester, and the copper component was dispersed in the light-absorbing composition E1 and that the light-absorbing composition E1 was transparent green in appearance. In the appearance color column of Table 2, “A” indicates that the appearance is transparent green, and “X” indicates that the appearance is not transparent green.

It is thought that since copper acetate monohydrate serving as a supply source of the copper component was used to produce the light-absorbing composition E1, acetic acid was generated as a byproduct in the course of generation of the reaction product (in particular, a copper phosphonate compound). However, the light-absorbing composition E1 did not have the distinctive smell of acetic acid, which suggests that the acetic acid had been sufficiently removed. This is attributable to effective functioning of the precipitation of the reaction product due to the action of a poor solvent, such as ethanol, on the reaction product, the process of purification by filtration or washing, and the process of solvent removal by distillation. In the production of the light-absorbing composition E1, ethanol was the first solvent, and toluene was the second solvent.

### (Calculation of Dry Mass Ratio)

An amount of 10 g (=M1) of the light-absorbing composition E1 was measured out with precision and put in an aluminum Petri dish, which was left to stand still on a hot plate set at a surface temperature of 180 °C. The Petri dish was kept standing still as it is for about 10 minutes, and almost complete vaporization of the liquid component in the Petri dish was confirmed. The mass of the Petri dish containing the dried light-absorbing composition was measured, and the mass of the Petri dish was subtracted from the measured value to determine dry mass m1 of the light-absorbing composition. A ratio m1/M1 was determined as a dry mass ratio. The dry mass ratio of the light-absorbing composition E1 according to Example 1 was 15.1 mass %.

### (Evaluation of Redispersibility)

In order to examine whether the reaction product included in the light-absorbing composition E1 has redispersibility, an attempt was made to redisperse the reaction product in a solvent same as the solvent used for the distillation. The amount of the solvent was adjusted so that the dry mass ratio of the light-absorbing composition E1 would be 10 mass %. Consequently, it was confirmed that the reaction product was redispersed and the light-absorbing composition was highly transparent and green in appearance and was in a good state with no opaque turbidity, which demonstrates high redispersibility. In the redispersibility column of Table 2, “A” indicates high redispersibility, and “X” indicates low redispersibility.

### (Measurement of Residual Acetic Acid Concentration in Light-Absorbing Composition)

A sample was taken in a small amount from the light-absorbing composition E1 according to Example 1. An appropriate amount of toluene was added thereto so that the dry mass ratio would be 10 mass %. A sample for measuring the residual acetic acid concentration was thus produced. Next, an appropriate amount of pure water was added to the sample for measuring the residual acetic acid concentration, and liquid-liquid extraction with water was performed. The aqueous layer was collected to prepare a measurement specimen for capillary electrophoresis (CE). Capillary electrophoresis was performed on the measurement specimen for CE by an indirect absorptiometric method using a CE apparatus (manufactured by Agilent Technologies, Inc.; product name: Agilent 1600). In this capillary electrophoresis, 2,6-pyridinedicarboxylic acid-based running solution (pH=12) was used as a running buffer, and a fused silica capillary was used. By this measurement, the amount of the acetic acid remaining in the light-absorbing composition E1 according to Example 1 was determined to be 0.08 mass %.

### (Measurement of Transmission Spectrum of Light-Absorbing Composition)

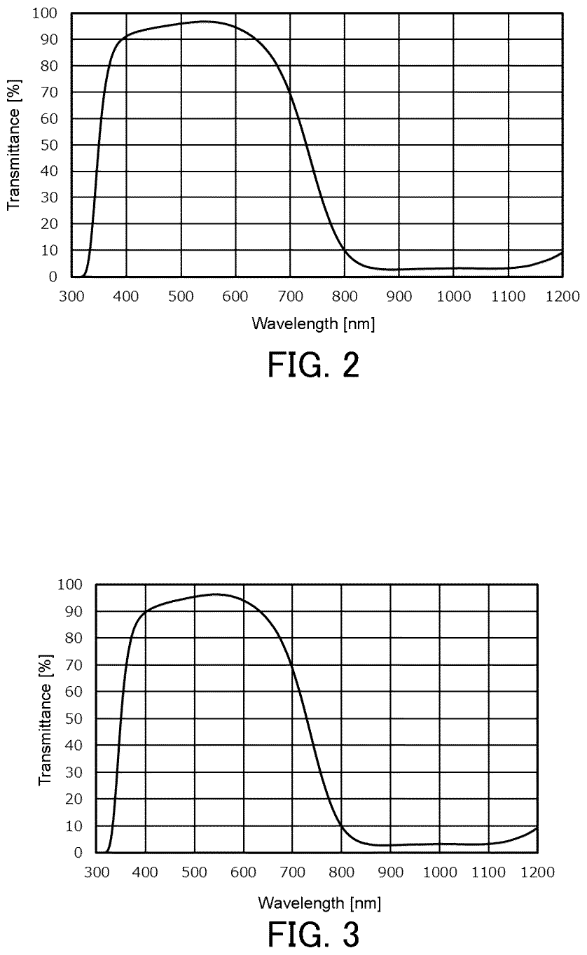

The light-absorbing composition E1 according to Example 1 was put in a quartz cell (manufactured by Starna Scientific Ltd.; product code: 20/C/Q1; optical path length: 1 mm; optical path width: 10 mm; outer dimensions: 3.5 mm in length, 12.5 mm in width, and 45 mm in height; capacity: 0.31 ml), and the transmittance at each wavelength in the wavelength range of 300 nm to 1200 nm was measured at an incident angle of 0° using an ultraviolet-visible-near-infrared spectrophotometer (manufactured by JASCO Corporation; product code: V770). After several adjustments, a sample for transmission spectrum measurement was prepared by adjusting the light-absorbing composition concentration with an appropriate amount of toluene which served as the solvent and thereby achieving a transmittance of 10%±1% at a wavelength of 800 nm. FIG. 2 shows a transmission spectrum of the light-absorbing composition according to Example 1. Table 3 shows parameters at a particular wavelength or in particular wavelength regions, the parameters being obtained from the transmission spectrum.

### Example 2

An amount of 36.67 g of a light-absorbing composition E2 according to Example 2 having a dry mass ratio of 17.0 mass % was produced using the following compounds as raw materials under the same conditions and by the same method as in Example 1. The appearance and the redispersibility of the light-absorbing composition E2 according to Example 2 evaluated under the same conditions and by the same method as in Example 1 were both satisfactory.

### [Raw Materials]

First solvent: methanol
Copper acetate monohydrate, 4.88 g
Phosphonic acid: butylphosphonic acid, 2.835 g
Phosphoric acid ester: PLYSURF A208N, 2.829 g
Second solvent: toluene, 80 g

### [Purification (Vacuum Distillation) Conditions]

Oil bath temperature: 85 °C; pressure: 600 hPa or less

### Example 3

An amount of 21.50 g of a light-absorbing composition E3 according to Example 3 having a dry mass ratio of 29.2 mass % was produced using the following compounds as raw materials under the same conditions and by the same method as in Example 1. The appearance and the redispersibility of the light-absorbing composition E3 according to Example 3 evaluated under the same conditions and by the same method as in Example 1 were both satisfactory. The acetic acid concentration in the light-absorbing composition E3 according to Example 3 measured under the same conditions and by the same method as in Example 1 was 0.11 mass %.

### [Raw Materials]

First solvent: methanol
Copper acetate monohydrate, 4.88 g
Phosphonic acid: butylphosphonic acid, 2.780 g
Phosphoric acid ester: PLYSURF A208F, 3.086 g
Second solvent: toluene, 60 g

### [Purification (Vacuum Distillation) Conditions]

Oil bath temperature: 85 °C; pressure: 600 hPa or less

### Example 4

An amount of 23.31 g of a light-absorbing composition E4 according to Example 4 having a dry mass ratio of 28.9 mass % was produced using the following compounds as raw materials under the same conditions and by the same method as in Example 1. The appearance and the redispersibility of the light-absorbing composition E4 according to Example 4 evaluated under the same conditions and by the same method as in Example 1 were both satisfactory.

### [Raw Materials]

First solvent: ethanol
Copper acetate monohydrate, 4.88 g
Phosphonic acid: butylphosphonic acid, 3.284 g
Phosphoric acid ester: NIKKOL DDP2 manufactured by Nikko Chemicals Co., Ltd., 3.088 g
Second solvent: toluene, 60 g

### [Purification (Vacuum Distillation) Conditions]

Oil bath temperature: 85 °C; pressure: 600 hPa or less

A transmission spectrum of the light-absorbing composition E4 according to Example 4 was measured under the same conditions and by the same method as in Example 1. FIG. 3 shows the transmission spectrum of the light-absorbing composition E4 according to Example 4. Table 3 shows specific parameters obtained from the transmission spectrum.

### Example 5

An amount of 22.56 g of a light-absorbing composition E5 according to Example 5 having a dry mass ratio of 29.5 mass % was produced using the following compounds as raw materials under the same conditions and by the same method as in Example 1. The appearance and the redispersibility of the light-absorbing composition E5 according to Example 5 evaluated under the same conditions and by the same method as in Example 1 were both satisfactory.

[Raw materials]
First solvent: methanol
Copper acetate monohydrate, 4.88 g
Phosphonic acid: butylphosphonic acid, 3.334 g
Phosphoric acid ester: NIKKOL DDP2, 2.984 g
Second solvent: toluene, 60 g

### [Purification (Vacuum Distillation) Conditions]

Oil bath temperature: 85 °C; pressure: 600 hPa or less

### Example 6

An amount of 18.86 g of a light-absorbing composition E6 according to Example 6 having a dry mass ratio of 27.9 mass % was produced using the following compounds as raw materials under the same conditions and by the same method as in Example 1. The appearance and the redispersibility of the light-absorbing composition E6 according to Example 6 evaluated under the same conditions and by the same method as in Example 1 were both satisfactory.

### [Raw Materials]

First solvent: ethanol
Copper acetate monohydrate, 4.88 g
Phosphonic acid: methylphosphonic acid, 2.019 g
Phosphoric acid ester: PLYSURF A208N, 2.572 g
Second solvent: toluene, 60 g

### [Purification (Vacuum Distillation) Conditions]

Oil bath temperature: 85 °C; pressure: 600 hPa or less

### Example 7

An amount of 19.23 g of a light-absorbing composition E7 according to Example 7 having a dry mass ratio of 29.4 mass % was produced using the following compounds as raw materials under the same conditions and by the same method as in Example 1. The appearance and the redispersibility of the light-absorbing composition E7 according to Example 7 evaluated under the same conditions and by the same method as in Example 1 were both satisfactory.

### [Raw Materials]

First solvent: ethanol
Copper acetate monohydrate, 4.88 g
Phosphonic acid: ethylphosphonic acid, 2.259 g
Phosphoric acid ester: PLYSURF A208N, 2.829 g
Second solvent: toluene, 60 g

### [Purification (Vacuum Distillation) Conditions]

Oil bath temperature: 85 °C; pressure: 600 hPa or less

### Example 8

An amount of 13.78 g of a light-absorbing composition E8 according to Example 8 having a dry mass ratio of 45.3 mass % was produced using the following compounds as raw materials under the same conditions and by the same method as in Example 1. The appearance and the redispersibility of the light-absorbing composition E8 according to Example 8 evaluated under the same conditions and by the same method as in Example 1 were both satisfactory. The acetic acid concentration in the light-absorbing composition E8 according to Example 8 measured under the same conditions and by the same method as in Example 1 was 0.10 mass %.

### [Raw Materials]

First solvent: ethanol
Copper acetate monohydrate, 4.88 g
Phosphonic acid: butylphosphonic acid, 2.977 g
Phosphoric acid ester: PLYSURF A208N, 2.829 g
Second solvent: toluene, 60 g

### [Purification (Vacuum Distillation) Conditions]

Oil bath temperature: 85 °C; pressure: 350 hPa or less

### Example 9

An amount of 11.94 g of a light-absorbing composition E9 according to Example 9 having a dry mass ratio of 50.3 mass % was produced using the following compounds as raw materials under the same conditions and by the same method as in Example 1. The appearance and the redispersibility of the light-absorbing composition E9 according to Example 9 evaluated under the same conditions and by the same method as in Example 1 were both satisfactory.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: toluene, 60 g

### [Purification (Vacuum Distillation) Conditions]

Oil bath temperature: 60 °C; pressure: 250 hPa or less

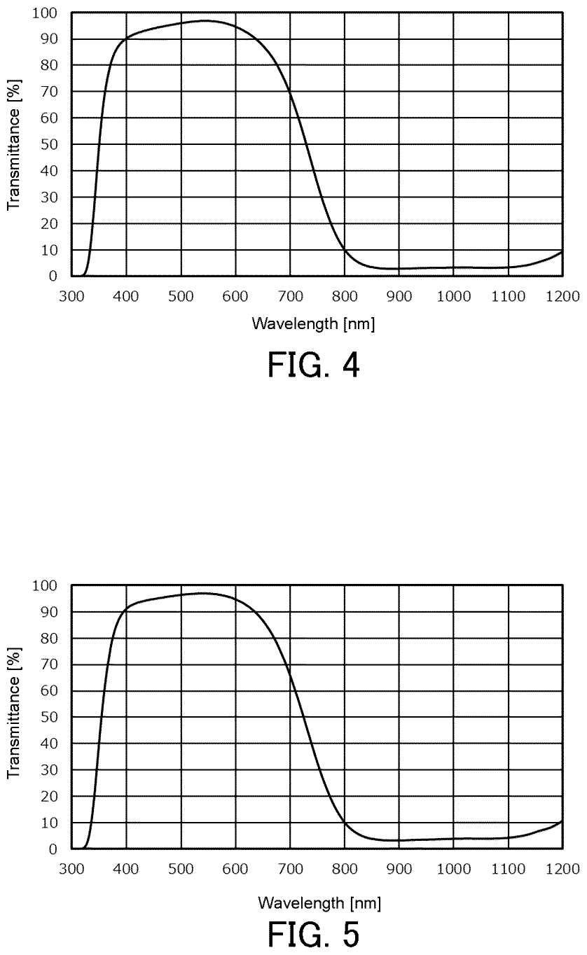

A transmission spectrum of the light-absorbing composition E9 according to Example 9 was measured under the same conditions and by the same method as in Example 1. FIG. 4 shows the transmission spectrum of the light-absorbing composition E9 according to Example 9. Table 3 shows specific parameters obtained from the transmission spectrum.

### Example 10

An amount of 13.45 g of a light-absorbing composition E10 according to Example 10 having a dry mass ratio of 49.4 mass % was produced using the following compounds as raw materials under the same conditions and by the same method as in Example 1. The appearance and the redispersibility of the light-absorbing composition E10 according to Example 10 evaluated under the same conditions and by the same method as in Example 1 were both satisfactory.

### [Raw Materials]

First solvent: methanol
Copper acetate monohydrate, 4.88 g
Phosphonic acid: butylphosphonic acid, 3.214 g
Phosphoric acid ester: NIKKOL DDP2, 3.008 g
Second solvent: toluene, 60 g

### [Purification (Vacuum Distillation) Conditions]

Oil bath temperature: 60 °C; pressure: 250 hPa or less

### Example 11

An amount of 4.88 g of copper acetate monohydrate (manufactured by KANTO CHEMICAL CO., INC.) and 195.12 g of ethanol (manufactured by KANTO CHEMICAL CO., INC., EL grade for the electronics industry) were mixed, and were stirred for three hours to give a copper acetate solution. Next, 2.829 g of a phosphoric acid ester compound (manufactured by DKS Co., Ltd.; product name: PLYSURF A208N) was added to the copper acetate solution, followed by stirring for 30 minutes to give a solution A11 being a copper acetate-phosphoric acid ester solution. Then, 2.977 g of n-butylphosphonic acid and 40 g of ethanol were added, and were stirred for 10 minutes to give a solution B11 being a phosphonic acid solution. Subsequently, the solution B11 was added to the solution A11 under stirring. This was followed by stirring at room temperature for 15 minutes to cause a reaction, giving a solution C11 being a phosphoric acid ester-phosphonic acid-copper solution. For the solution C11, settlement of solids assumed to have been generated by the reaction was able to be visually confirmed. The reaction product is considered to be a compound including a portion or all of the phosphonic acid, the phosphoric acid ester, and the copper component.

The solution C11 was subjected to suction filtration to give solids of the reaction product. The solid reaction product was added to 200 g of ethanol, and was stirred at room temperature for 10 minutes. Then, suction filtration was performed again to give a solid reaction product obtained after one purification. Furthermore, this solid reaction product obtained after one purification was added to 140 g of methylene chloride, followed by stirring at room temperature for 10 minutes to give a solution D11. For the solution D11, no solids of the reaction product were visually observed, and the reaction product was dispersed therein. This indicates that a certain amount of a phosphoric acid ester having the dispersing effect was included in the solid reaction product and the phosphoric acid ester contributed to the dispersion of the reaction product in the methylene chloride.

The solution D11 was placed in a flask and subjected to solvent removal using a rotary evaporator (manufactured by Tokyo Rikakikai Co., Ltd.; product code: N-1110SF) under heating by means of an oil bath (manufactured by Tokyo Rikakikai Co., Ltd.; product code: OSB-2100) set at 45 °C. During this operation, the flask was carefully depressurized stepwise from the atmospheric pressure to 600 hPa or less using a vacuum pump to prevent bumping. The operation was finished after confirming that the solvent had decreased to a certain amount. An amount of 38.18 g of a light-absorbing composition E11 according to Example 11 was obtained in this manner. In the production of the light-absorbing composition E11, ethanol was the first solvent, and methylene chloride was the second solvent.

The dry mass ratio calculated for the light-absorbing composition E11 according to Example 11 under the same conditions and by the same method as in Example 1 was 16.3%. The appearance and the redispersibility of the light-absorbing composition E11 according to Example 11 evaluated under the same conditions and by the same method as in Example 1 were both satisfactory. Table 1 also shows the raw materials of the light-absorbing composition E11 according to Example 11 and the evaluation results for the appearance and the redispersibility thereof. It was confirmed that the reaction product including a portion or all of the phosphonic acid, the phosphoric acid ester, and the copper component was dispersed in the light-absorbing composition E11 according to Example 11 and that the light-absorbing composition E11 was transparent and green in appearance. The acetic acid concentration in the light-absorbing composition E11 according to Example 11 measured in the same manner as in Example 1 was 0.09 mass %.

A transmission spectrum of the light-absorbing composition E11 according to Example 11 was measured under the same conditions and by the same method as in Example 1. FIG. 5 shows the transmission spectrum of the light-absorbing composition E11 according to Example 11. Table 3 shows specific parameters obtained from the transmission spectrum.

### Example 12

An amount of 37.54 g of a light-absorbing composition E12 according to Example 12 having a dry mass ratio of 17.8 mass % was produced using the following compounds as raw materials under the same conditions and by the same method as in Example 11. The appearance and the redispersibility of the light-absorbing composition according to Example 12 evaluated under the same conditions and by the same method as in Example 1 were both satisfactory.

### [Raw Materials]

First solvent: methanol
Copper acetate monohydrate, 4.88 g
Phosphonic acid: butylphosphonic acid, 3.334 g
Phosphoric acid ester: NIKKOL DDP2, 2.984 g
Second solvent: methylene chloride, 140 g

### [Purification (Vacuum Distillation) Conditions]

Oil bath temperature: 45 °C; pressure: 600 hPa or less

### Example 13

An amount of 23.71 g of a light-absorbing composition E13 according to Example 13 having a dry mass ratio of 24.5 mass % was produced using the following compounds as raw materials under the same conditions and by the same method as in Example 11. The appearance and the redispersibility of the light-absorbing composition E13 according to Example 13 evaluated under the same conditions and by the same method as in Example 1 were both satisfactory. The acetic acid concentration in the light-absorbing composition E13 according to Example 13 measured under the same conditions and by the same method as in Example 1 was 0.10 mass %.

### [Raw Materials]

First solvent: ethanol
Copper acetate monohydrate, 4.88 g
Phosphonic acid: butylphosphonic acid, 2.943 g
Phosphoric acid ester: PLYSURF A208N, 2.315 g
Second solvent: methylene chloride, 100 g

### [Purification (Vacuum Distillation) Conditions]

Oil bath temperature: 45 °C; pressure: 600 hPa or less

A transmission spectrum of the light-absorbing composition E13 according to Example 13 was measured under the same conditions and by the same method as in Example 1. Table 3 shows specific parameters obtained from the transmission spectrum.

### Example 14

An amount of 15.68 g of a light-absorbing composition E14 according to Example 14 having a dry mass ratio of 37.9 mass % was produced using the following compounds as raw materials under the same conditions and by the same method as in Example 11. The appearance and the redispersibility of the light-absorbing composition E14 according to Example 14 evaluated under the same conditions and by the same method as in Example 1 were both satisfactory. Table 1 also shows the raw materials of the light-absorbing composition 14E according to Example 14 and the evaluation results for the appearance and the redispersibility thereof.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: methylene chloride, 100 g

### [Purification (Vacuum Distillation) Conditions]

Oil bath temperature: 45 °C; pressure: 600 hPa or less

A transmission spectrum of the light-absorbing composition E14 according to Example 14 was measured under the same conditions and by the same method as in Example 1. Table 3 shows specific parameters obtained from the transmission spectrum.

### Example 15

An amount of 11.88 g of a light-absorbing composition E15 according to Example 15 having a dry mass ratio of 51.7 mass % was produced using the following compounds as raw materials under the same conditions and by the same method as in Example 11. The appearance and the redispersibility of the light-absorbing composition E15 according to Example 15 evaluated under the same conditions and by the same method as in Example 1 were both satisfactory. The acetic acid concentration in the light-absorbing composition E15 according to Example 15 measured under the same conditions and by the same method as in Example 1 was 0.15 mass %.

### [Raw Materials]

First solvent: ethanol
Copper acetate monohydrate, 4.88 g
Phosphonic acid: butylphosphonic acid, 2.835 g
Phosphoric acid ester: PLYSURF A208N, 2.829 g
Second solvent: methylene chloride, 100 g

### [Purification (Vacuum Distillation) Conditions]

Oil bath temperature: 45 °C; pressure: 350 hPa or less

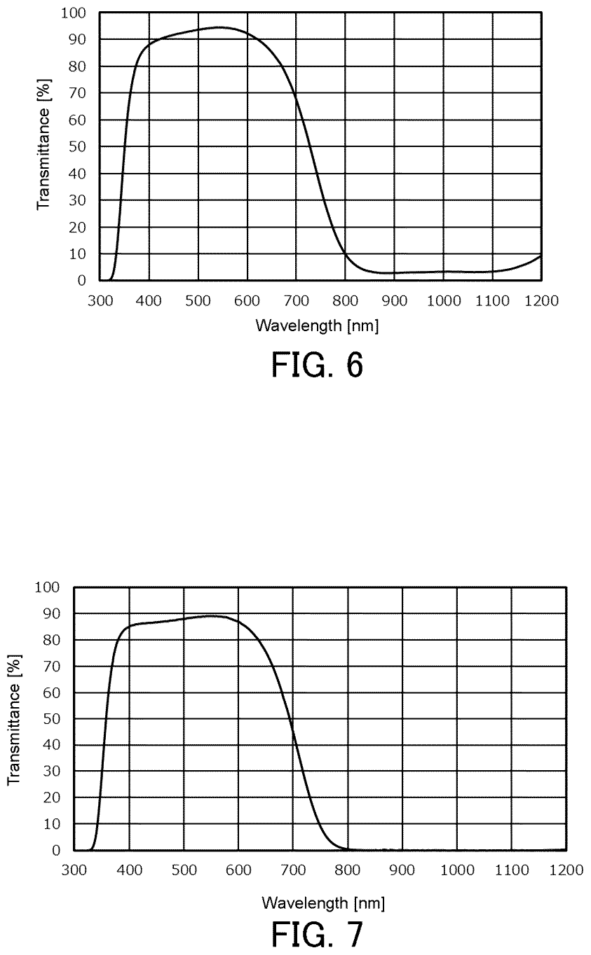

A transmission spectrum of the light-absorbing composition E15 according to Example 15 was measured under the same conditions and by the same method as in Example 1. FIG. 6 shows a transmission spectrum of the light-absorbing composition E15 according to Example 15. Table 3 shows specific parameters obtained from the transmission spectrum.

### Comparative Example 1

An amount of 10.31 g of a light-absorbing composition according to Comparative Example 1 having a dry mass ratio of 57.7 mass % was produced using the following compounds as raw materials under the same conditions and by the same method as in Example 1. In the final vacuum distillation, evaporation and removal of the solvent were promoted excessively. According to evaluation performed under the same conditions and by the same method as in Example 1, the color of the appearance of the light-absorbing composition according to Comparative Example 1 was satisfactory, but a solution prepared by redispersion thereof developed turbidity. The initial dispersibility was acceptable. However, it is suggested that the dispersibility decreased by the redispersion and thus partial aggregation occurred. Table 1 also shows the raw materials of the light-absorbing composition according to Comparative Example 1 and the evaluation results for the appearance and the redispersibility thereof.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: toluene, 60 g

### [Purification (Vacuum Distillation) Conditions]

Oil bath temperature: 60 °C; pressure: 250 hPa or less

### Comparative Example 2

An amount of 8.91 g of a light-absorbing composition according to Comparative Example 2 whose dry mass ratio was 67.0 mass % was produced using the following compounds as raw materials under the same conditions and by the same method as in Example 1. In the final vacuum distillation, evaporation and removal of the solvent were promoted more excessively than in Comparative Example 1. According to evaluation performed under the same conditions and by the same method as in Example 1, the light-absorbing composition according to Comparative Example 2 had a milky yellow color in appearance, and was not in a highly transparent green solution state as observed in Examples and Comparative Example 1. It is suggested that the light-absorbing composition according to Comparative Example 2 made no contribution to solution of the problem to be addressed by the present invention. Table 1 also shows the raw materials of the light-absorbing composition according to Comparative Example 2 and the evaluation results for the appearance and the redispersibility thereof.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: toluene, 60 g

### [Purification (Vacuum Distillation) Conditions]

Oil bath temperature: 60 °C; pressure: 250 hPa or less

### Comparative Example 3

An amount of 10.21 g of a light-absorbing composition according to Comparative Example 3 having a dry mass ratio of 58.4 mass % was produced using the following compounds as raw materials under the same conditions and by the same method as in Example 11. In the final vacuum distillation, evaporation and removal of the solvent were promoted excessively. According to evaluation performed under the same conditions and by the same method as in Example 1, the color of the appearance of the light-absorbing composition according to Comparative Example 3 was satisfactory, but a solution prepared by redispersion thereof developed turbidity. The initial dispersibility was acceptable. However, it is suggested that the dispersibility decreased by the redispersion and thus partial aggregation occurred. Table 1 also shows the raw materials of the light-absorbing composition according to Comparative Example 3 and the evaluation results for the appearance and the redispersibility thereof.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: methylene chloride, 100 g

### [Purification (Vacuum Distillation) Conditions]

Oil bath temperature: 45 °C; pressure: 350 hPa or less

### Comparative Example 4

An amount of 8.56 g of a light-absorbing composition according to Comparative Example 4 having a dry mass ratio of 69.5 mass % was produced using the following compounds as raw materials under the same conditions and by the same method as in Example 11. In the final vacuum distillation, evaporation and removal of the solvent were promoted more excessively than in Comparative Example 1. According to evaluation performed under the same conditions and by the same method as in Example 1, the light-absorbing composition according to Comparative Example 4 had a milky yellow color in appearance, and was not in a highly transparent green solution state as observed in Examples and Comparative Examples 1 and 3. It is suggested that the light-absorbing composition according to Comparative Example 4 made no contribution to solution of the problem to be addressed by the present invention. Table 1 also shows the raw materials of the light-absorbing composition according to Comparative Example 4 and the evaluation results for the appearance and the redispersibility thereof.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: methylene chloride, 100 g

### [Purification (Vacuum Distillation) Conditions]

Oil bath temperature: 45 °C; pressure: 350 hPa or less

### Comparative Example 5

An amount of 93.18 g of a light-absorbing composition according to Comparative Example 5 whose dry mass ratio was 6.4 mass % was produced using the following compounds as raw materials under the same conditions and by the same method as in Example 1. In the final vacuum distillation, depressurization was not performed, and the scale of evaporation and removal of the solvent was reduced. According to evaluation performed under the same conditions and by the same method as in Example 1, the color of the appearance of the light-absorbing composition according to Comparative Example 5 was satisfactory, but a solution prepared by redispersion thereof developed turbidity. The initial dispersibility was acceptable. However, it is suggested that the dispersibility decreased by the redispersion and thus partial aggregation occurred. Table 1 also shows the raw materials of the light-absorbing composition according to Comparative Example 5 and the evaluation results for the appearance and the redispersibility thereof.

### [Raw Materials]

First solvent: ethanol
Copper acetate monohydrate, 4.88 g
Phosphonic acid: butylphosphonic acid, 2.886 g
Phosphoric acid ester: PLYSURF A208N, 2.572 g
Second solvent: toluene, 140 g

### [Purification (Vacuum Distillation) Conditions]

Oil bath temperature: 105 °C; Not depressurized

### (Production of Composition for Light-Absorbing Film)

### Example 16

Toluene as a solvent and a silicone resin (KR-300 manufactured by Shin-Etsu Chemical Co., Ltd.) were added to the light-absorbing composition E1 according to Example 1 so that the dry mass ratio would be 50 mass %, followed by stirring at ordinary temperature for 30 minutes to produce a composition according to Example 16 for a light-absorbing film. The composition for a light-absorbing film was produced such that the resin was dissolved in advance in the solvent before they were added to the light-absorbing composition. The dry mass ratio in the composition for a light-absorbing film refers to a ratio of the sum of the dry mass of the light-absorbing composition included and the mass of the solid content of the resin component added to the total mass of the composition for a light-absorbing film (the same is applicable to Examples 17 to 21).

### Example 17

Toluene as a solvent and a silicone resin (KR-300 manufactured by Shin-Etsu Chemical Co., Ltd.) were added to the light-absorbing composition E4 according to Example 4 so that the dry mass ratio would be 30 mass %, followed by stirring at ordinary temperature for 30 minutes to produce a composition according to Example 17 for a light-absorbing film. The composition for a light-absorbing film was produced such that the resin was dissolved in advance in the solvent before they were added to the light-absorbing composition.

### Example 18

Toluene as a solvent and a silicone resin (KR-300 manufactured by Shin-Etsu Chemical Co., Ltd.) were added to the light-absorbing composition according to Example 9 so that the dry mass ratio would be 25 mass %, followed by stirring at ordinary temperature for 30 minutes to produce a composition according to Example 18 for a light-absorbing film. The composition for a light-absorbing film was produced such that the resin was dissolved in advance in the solvent before they were added to the light-absorbing composition.

### Example 19

Toluene as a solvent and a cyclic olefin resin (ZEONOR 1060R manufactured by Zeon Corporation) were added to the light-absorbing composition according to Example 9 so that the dry mass ratio would be 30 mass %, followed by stirring at ordinary temperature for 30 minutes to produce a composition according to Example 19 for a light-absorbing film. The composition for a light-absorbing film was produced such that the resin was dissolved in advance in the solvent before they were added to the light-absorbing composition.

### Example 20

Methylene chloride as a solvent and a silicone resin (KR-300 manufactured by Shin-Etsu Chemical Co., Ltd.) were added to the light-absorbing composition according to Example 11 so that the dry mass ratio would be 50 mass %, followed by stirring at ordinary temperature for 30 minutes to produce a composition according to Example 20 for a light-absorbing film. The composition for a light-absorbing film was produced such that the resin was dissolved in advance in the solvent before they were added to the light-absorbing composition.

### Example 21

Methylene chloride as a solvent and a silicone resin (KR-300 manufactured by Shin-Etsu Chemical Co., Ltd.) were added to the light-absorbing composition according to Example 15 so that the dry mass ratio would be 50 mass %, followed by stirring at ordinary temperature for 30 minutes to produce a composition according to Example 21 for a light-absorbing film. The composition for a light-absorbing film was produced such that the resin was dissolved in advance in the solvent before they were added to the light-absorbing composition.

### (Production of Light-Absorbing Film)

### Example 22

A plate-shaped transparent borosilicate glass (D263 T eco manufactured by SCHOTT AG) having dimensions of 76 mm×76 mm×0.21 mm was prepared as a support (support glass). A principal surface of the glass had an arithmetic average roughness Ra of less than 1 nm, providing sufficient flatness and smoothness. This support glass was washed sequentially with acetone, ethanol, and pure water. A stainless steel frame having dimensions of 70 mm×70 mm in plan view and having a 60 mm×60 mm opening portion was disposed on the principal surface of the plate-shaped support glass such that the opening portion was approximately at the center of the support glass. The frame had a height (thickness) of approximately 1 mm. An appropriate amount of the composition according to Example 16 was supplied to the opening portion of the frame on the support glass using a dispenser equipped, at its tip, with a chip with a built-in filter having a particle retention size of 5 μm. The supplied composition was left to stand still for an appropriate period of time so as to be cast within the entire opening portion. A work having a uniform coating film (cast film) on the support glass was thus obtained. This work was put into a convection oven and heated at an actual inner temperature of 85 °C for six hours, after which the work was taken out of the oven. The cast film on the support glass was solidified and united with the support glass. A light-absorbing film according to Example 22 was produced, as described above, by casting on the support. The light-absorbing film on the support glass had a thickness of 115 μm. The thickness of the light-absorbing film was measured using a laser displacement meter LK-H008 manufactured by Keyence Corporation.

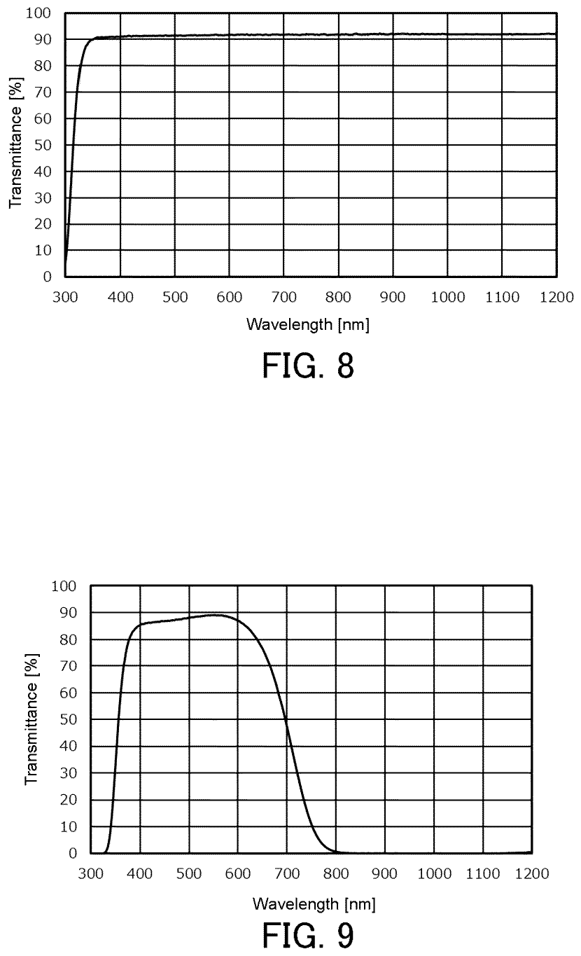

For an optical filter according to Example 22 including the support and the light-absorbing film, the transmittance at each wavelength in the wavelength range of 300 nm to 1200 nm was measured at an incident angle of 0° using an ultraviolet-visible-near-infrared spectrophotometer (manufactured by JASCO Corporation; product code: V770) to give a transmission spectrum of the optical filter according to Example 22. FIG. 7 shows the transmission spectrum of the optical filter according to Example 22. Table 4 shows parameters relating to wavelengths and transmittances, the parameters being obtained from the transmission spectrum. FIG. 8 shows a transmission spectrum of borosilicate glass (D263 T eco manufactured by SCHOTT AG; thickness: 0.21 mm) used as the support at an incident angle of 0°. The transmittance of the glass used as the support is substantially constant in the wavelength range of 350 nm or more, and a decrease in transmittance due to Fresnel reflection at the interface between the glass and air can be confirmed.

### Example 23

A light-absorbing film and an optical filter according to Example 23 were produced in the same manner as in Example 22, except that the composition according to Example 17 for a light-absorbing film was used instead of the composition according to Example 16 for a light-absorbing film. The light-absorbing film on the support had a thickness of 207 μm. A transmission spectrum of the optical filter according to Example 23 was measured by the same method as in Example 22. FIG. 9 shows the transmission spectrum of the light-absorbing film according to Example 23. Table 4 shows parameters relating to wavelengths and transmittances, the parameters being obtained from the transmission spectrum.

### Example 24

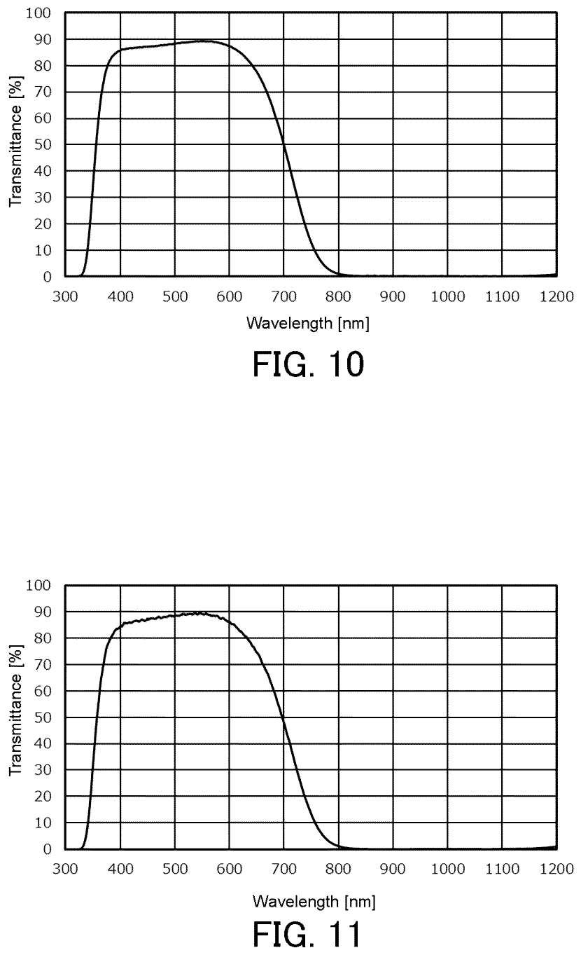

A light-absorbing film and an optical filter according to Example 24 were produced in the same manner as in Example 22, except that the composition according to Example 18 for a light-absorbing film was used instead of the composition according to Example 16 for a light-absorbing film. The light-absorbing film on the support had a thickness of 192 μm. A transmission spectrum of the optical filter according to Example 24 was measured by the same method as in Example 22. FIG. 10 shows the transmission spectrum of the light-absorbing film according to Example 24. Table 4 shows parameters relating to wavelengths and transmittances, the parameters being obtained from the transmission spectrum.

### Example 25

A light-absorbing film and an optical filter according to Example 25 were produced in the same manner as in Example 22, except that the composition according to Example 19 for a light-absorbing film was used instead of the composition according to Example 16 for a light-absorbing film. The light-absorbing film on the support had a thickness of 205 μm. A transmission spectrum of the optical filter according to Example 25 was measured by the same method as in Example 22. FIG. 11 shows the transmission spectrum of the light-absorbing film according to Example 25. Table 4 shows parameters relating to wavelengths and transmittances, the parameters being obtained from the transmission spectrum.

### Example 26

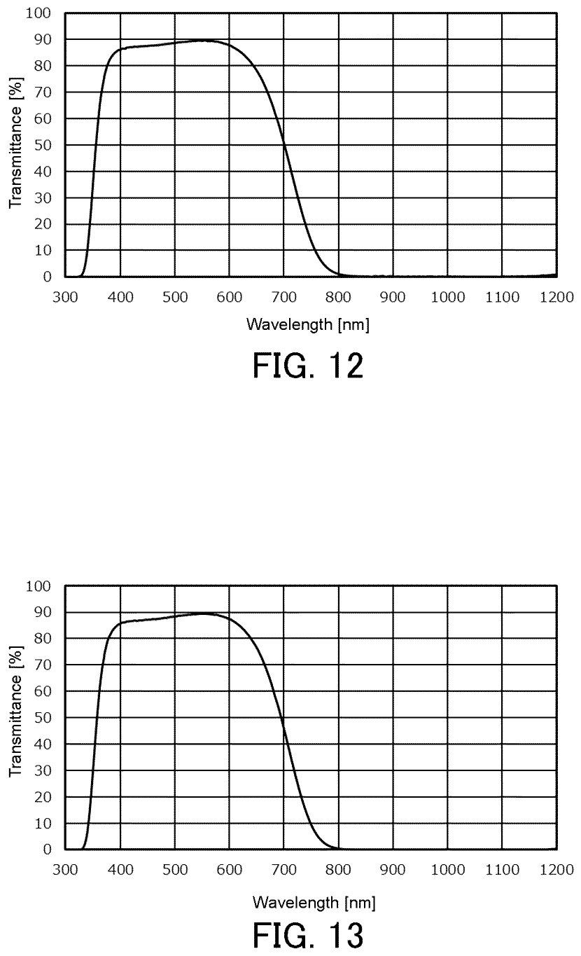

A light-absorbing film and an optical filter according to Example 26 were produced in the same manner as in Example 22, except that the composition according to Example 20 for a light-absorbing film was used instead of the composition according to Example 16 for a light-absorbing film. The light-absorbing film on the support had a thickness of 93 μm. A transmission spectrum of the optical filter according to Example 26 was measured by the same method as in Example 22. FIG. 12 shows the transmission spectrum of the light-absorbing film according to Example 26. Table 4 shows parameters relating to wavelengths and transmittances, the parameters being obtained from the transmission spectrum.

### Example 27

A light-absorbing film and an optical filter according to Example 27 were produced in the same manner as in Example 22, except that the composition according to Example 21 for a light-absorbing film was used instead of the composition according to Example 16 for a light-absorbing film. The light-absorbing film on the support had a thickness of 103 μm. A transmission spectrum of the optical filter according to Example 27 was measured by the same method as in Example 22. FIG. 13 shows the transmission spectrum of the light-absorbing film according to Example 27. Table 4 shows parameters relating to wavelengths and transmittances, the parameters being obtained from the transmission spectrum.

TABLE 1

| | First | Copper compound | | Phosphonic acid | | Phosphoric acid ester | |
|---|---|---|---|---|---|---|---|
| | solvent | Type | Amount [g] | Type | Amount [g] | Type (Code) | Amount [g] |
| Ex. 1 | Ethanol | CAM | 4.880 | BPA | 2.886 | A208N | 2.572 |
| Ex. 2 | Methanol | CAM | 4.880 | BPA | 2.835 | A208N | 2.829 |
| Ex. 3 | Methanol | CAM | 4.880 | BPA | 2.780 | A208F | 3.086 |
| Ex. 4 | Ethanol | CAM | 4.880 | BPA | 3.284 | DDP2 | 3.088 |
| Ex. 5 | Methanol | CAM | 4.880 | BPA | 3.334 | DDP2 | 2.984 |
| Ex. 6 | Ethanol | CAM | 4.880 | MPA | 2.019 | A208N | 2.572 |
| Ex. 7 | Ethanol | CAM | 4.880 | EPA | 2.259 | A208N | 2.829 |
| Ex. 8 | Ethanol | CAM | 4.880 | BPA | 2.977 | A208N | 2.829 |
| Ex. 9 | Ethanol | CAM | 4.880 | BPA | 2.886 | A208N | 2.572 |
| Ex. 10 | Methanol | CAM | 4.880 | BPA | 3.214 | DDP2 | 3.008 |
| Ex. 11 | Ethanol | CAM | 4.880 | BPA | 2.977 | A208N | 2.829 |
| Ex. 12 | Methanol | CAM | 4.880 | BPA | 3.334 | DDP2 | 2.984 |
| Ex. 13 | Ethanol | CAM | 4.880 | BPA | 2.943 | A208N | 2.315 |
| Ex. 14 | Ethanol | CAM | 4.880 | BPA | 2.886 | A208N | 2.572 |
| Ex. 15 | Ethanol | CAM | 4.880 | BPA | 2.835 | A208N | 2.829 |
| Comp. | Ethanol | CAM | 4.880 | BPA | 2.886 | A208N | 2.572 |
| Ex. 1 | | | | | | | |
| Comp. | Ethanol | CAM | 4.880 | BPA | 2.886 | A208N | 2.572 |
| Ex. 2 | | | | | | | |
| Comp. | Ethanol | CAM | 4.880 | BPA | 2.886 | A208N | 2.572 |
| Ex. 3 | | | | | | | |
| Comp. | Ethanol | CAM | 4.880 | BPA | 2.886 | A208N | 2.572 |
| Ex. 4 | | | | | | | |
| Comp. | Ethanol | CAM | 4.880 | BPA | 2.886 | A208N | 2.572 |
| Ex. 5 | | | | | | | |

| | | Light- | | |
|---|---|---|---|---|
| | | absorbing | Dry mass | Acetic acid |
| | Second | Composition | ratio | concentration |
| | solvent | [g] | [mass %] | [mass %] |
| Ex. 1 | Toluene | 39.71 | 15.1 | 0.08 |
| Ex. 2 | Toluene | 36.67 | 17.0 | |
| Ex. 3 | Toluene | 21.50 | 29.2 | 0.11 |
| Ex. 4 | Toluene | 23.31 | 28.9 | |
| Ex. 5 | Toluene | 22.56 | 29.5 | |
| Ex. 6 | Toluene | 18.86 | 27.9 | |
| Ex. 7 | Toluene | 19.23 | 29.4 | |
| Ex. 8 | Toluene | 13.78 | 45.3 | 0.10 |
| Ex. 9 | Toluene | 11.94 | 50.3 | |
| Ex. 10 | Toluene | 13.45 | 49.4 | |
| Ex. 11 | Methylene | 38.18 | 16.3 | 0.09 |
| | chloride | | | |
| Ex. 12 | Methylene | 37.54 | 17.8 | |
| | chloride | | | |
| Ex. 13 | Methylene | 23.71 | 24.5 | 0.10 |
| | chloride | | | |
| Ex. 14 | Methylene | 15.68 | 37.9 | |
| | chloride | | | |
| Ex. 15 | Methylene | 11.88 | 51.7 | 0.15 |
| | chloride | | | |
| Comp. | Toluene | 10.31 | 57.7 | |
| Ex. 1 | | | | |
| Comp. | Toluene | 8.91 | 67.0 | |
| Ex. 2 | | | | |
| Comp. | Methylene | 10.21 | 58.4 | |
| Ex. 3 | chloride | | | |
| Comp. | Methylene | 8.56 | 69.5 | |
| Ex. 4 | chloride | | | |
| Comp. | Toluene | 93.18 | 6.4 | |
| Ex. 5 | | | | |

Note
CAM: copper acetate monohydrate BPA: butylphosphonic acid MPA: methylphosphonic acid EPA: ethylphosphonic acid A208N: PLYSURF A208N (manufactured by DKS Co., Ltd.) A208F: PLYSURF A208F (manufactured by DKS Co., Ltd.) DDP2: NIKKOL DDP2 (manufactured by Nikko Chemicals Co., Ltd.)

TABLE 2

| | Appearance | |
|---|---|---|
| | color | Redispersibility |
| Example 1 | A | A |
| Example 2 | A | A |
| Example 3 | A | A |
| Example4 | A | A |
| Example 5 | A | A |
| Example 6 | A | A |
| Example 7 | A | A |
| Example 8 | A | A |
| Example 9 | A | A |
| Example 10 | A | A |
| Example 11 | A | A |
| Example 12 | A | A |
| Example 13 | A | A |
| Example 14 | A | A |
| Example 15 | A | A |
| Comparative | A | X |
| Example 1 | | |
| Comparative | X | — |
| Example 2 | | |
| Comparative | A | X |
| Example 3 | | |
| Comparative | X | — |
| Example 4 | | |
| Comparative | A | X |
| Example 5 | | |

TABLE 3

| | | | | | Standard | | | |
|---|---|---|---|---|---|---|---|---|
| | | Average | Average | Average | deviation of | Cut-off | Cut-off | Wavelength |
| | | transmittance | transmittance | transmittance | transmittances | wavelength in | wavelength in | width where |
| | Transmittance | in wavelength | in wavelength | in wavelength | in wavelength | wavelength | wavelength | transmittance |
| | at wavelength | range of 800 | range of 460 | range of 1100 | range of 900 | range of 300 | range of 600 | is 50% or |
| | of 800 nm | nm to 1100 nm | nm to 580 nm | nm to 1200 nm | nm to 1100 nm | nm to 400 nm | nm to 800 nm | more |
| | [%] | [%] | [%] | [%] | [%] | [nm] | [nm] | [nm] |
| Ex. 1 | 9.9 | 3.5 | 96.1 | 5.4 | 0.13 | 350 | 730 | 380 |
| Ex. 3 | 10.0 | 4.4 | 96.1 | 5.6 | 0.17 | 350 | 729 | 379 |
| Ex. 4 | 10.2 | 3.9 | 96.2 | 6.1 | 0.21 | 351 | 733 | 382 |
| Ex. 8 | 9.9 | 3.5 | 96.0 | 5.4 | 0.13 | 351 | 730 | 379 |
| Ex. 9 | 10.1 | 4.0 | 96.3 | 6.5 | 0.25 | 355 | 725 | 370 |
| Ex. 11 | 10.1 | 3.6 | 95.9 | 5.5 | 0.19 | 353 | 729 | 376 |
| Ex. 13 | 9.8 | 3.7 | 96.0 | 6.8 | 0.22 | 355 | 731 | 376 |
| Ex. 14 | 9.9 | 3.8 | 96.1 | 5.9 | 0.17 | 349 | 732 | 383 |
| Ex. 15 | 10.0 | 3.5 | 96.1 | 5.4 | 0.13 | 350 | 730 | 380 |

TABLE 4

| | Average | | | | |
|---|---|---|---|---|---|
| | transmittance | Average | | | |
| | in wavelength | transmittance | | | |
| | range of 800 | in wavelength | Transmittance | Transmittance | Transmittance |
| | nm to 1100 | range of 460 | at wavelength | at wavelength | at wavelength |
| | nm | nm to 580 nm | of 800 nm | of 900 nm | of 950 nm |
| | [%] | [%] | [%] | [%] | [%] |
| Ex. 22 | 0.1 | 88.3 | 0.5 | 0.1 | 0.1 |
| Ex. 23 | 0.1 | 88.4 | 0.7 | 0.1 | 0.1 |
| Ex. 24 | 0.2 | 88.6 | 1 | 0.1 | 0.1 |
| Ex. 25 | 0.2 | 88.5 | 1.3 | 0.1 | 0.2 |
| Ex. 26 | 0.2 | 89 | 1.1 | 0.1 | 0.2 |
| Ex. 27 | 0.1 | 88.6 | 0.5 | 0.1 | 0.1 |

| | | | Cut-off | Cut-off | |
|---|---|---|---|---|---|
| | | | wavelength | wavelength | |
| | | | in | in | |
| | | | wavelength | wavelength | Thickness |
| | Transmittance | Transmittance | range of | range of | of light- |
| | at wavelength | at wavelength | 300 nm to | 600 nm to | absorbing |
| | of 1000 nm | of 1100 nm | 400 nm | 800 nm | film |
| | [%] | [%] | [nm] | [nm] | [μm] |
| Ex. 22 | 0.1 | 0.1 | 358 | 694 | 115 |
| Ex. 23 | 0.1 | 0.1 | 357 | 698 | 207 |
| Ex. 24 | 0.1 | 0.1 | 356 | 700 | 192 |
| Ex. 25 | 0.2 | 0.2 | 358 | 697 | 205 |
| Ex. 26 | 0.2 | 0.1 | 356 | 701 | 93 |
| Ex. 27 | 0.1 | 0.1 | 358 | 695 | 103 |

1. A light-absorbing composition comprising:
a light-absorbing compound containing phosphorus and copper; and
a solvent, wherein
a ratio of dry mass of the light-absorbing composition to mass of the light-absorbing composition is 15% to 55%.

2. The light-absorbing composition according to claim 1, wherein the light-absorbing compound comprises a copper component and at least one selected from the group consisting of a phosphonic acid and a phosphoric acid ester.

3. The light-absorbing composition according to claim 1, wherein an acid concentration is 0.2 mass % or less.

4. The light-absorbing composition according to claim 1, having a transmission spectrum satisfying the following requirements (i) to (iv):
(i) an average transmittance in a wavelength range of 800 nm to 1100 nm is 20% or less;
(ii) an average transmittance in a wavelength range of 460 nm to 580 nm is 80% or more;
(iii) a wavelength that lies in a wavelength range from 300 nm to 400 nm and at which a transmittance is 50% is between 320 nm and 380 nm, inclusive; and
(iv) a wavelength that lies in a wavelength range from 600 nm to 800 nm and at which a transmittance is 50% is between 680 nm and 780 nm, inclusive.

5. The light-absorbing composition according to claim 4, wherein the transmission spectrum satisfies the following requirement (v):
(v) in a wavelength range from 300 nm to 1200 nm, a wavelength width in which a transmittance is 50% or more is 350 nm to 420 nm.

6. The light-absorbing composition according to claim 4, wherein the transmission spectrum satisfies the following requirement (vi):
(vi) an average transmittance in a wavelength range of 1100 nm to 1200 nm is 10% or less.

7. The light-absorbing composition according to claim 4, wherein the transmission spectrum satisfies the following requirement (vii):
(vii) a standard deviation of transmittances in a wavelength range from 900 nm to 1100 nm is 0.5% or less.

8. A method for producing a light-absorbing composition, the method comprising:
mixing a phosphorus-containing compound and a copper salt in a first solvent;
separating the first solvent to obtain solids containing phosphorus and copper; and
adjusting a ratio of dry mass of the light-absorbing composition to mass of the light-absorbing composition to 15% to 55% by adding the solids to a second solvent and performing distillation.

9. The method according to claim 8, wherein an acid concentration is less than 0.2 mass %.

10. The method according to claim 8, wherein the distillation is performed at 100 °C or lower.

11. The method according to claim 10, wherein the distillation is performed at a pressure lower than atmospheric pressure.

12-14. (canceled)
